(19) United States
(12) Patent Application Publication
(10) Pub. No.: US 2018/0232786 A1
(43) Pub. Date: Aug. 16, 2018

(54) SYSTEM AND METHOD FOR MATCHING REVENUE STREAMS IN A CLOUD SERVICE BROKER PLATFORM

(71) Applicant: Ingram Micro Inc., Irvine, CA (US)

(72) Inventors: Maxim Kuzkin, Irvine, CA (US); Vladimir Zatsepin, Mytishchi (RU); Pavel Khodos, Irvine, CA (US); Oleg Melnikov, Kirkland, WA (US); Vladimir Grebenschikov, Moscow (RU); Andrey Bolotov, Moscow (RU); Sergey Ulitsky, Moscow (RU); Gleb Averchyk, Moscow (RU); Fedor Kolesnikov, Iventeevka (RU); Evgeniy Likhtanskiy, Moscow (RU)

(21) Appl. No.: 15/954,238

(22) Filed: Apr. 16, 2018

Related U.S. Application Data
(63) Continuation-in-part of application No. 15/857,305, filed on Dec. 28, 2017.
(60) Provisional application No. 62/439,619, filed on Dec. 28, 2016.

(51) Int. Cl. G06Q 30/04; G06Q 30/06; G06Q 20/08; G06Q 20/12; H04L 29/08

(52) U.S. Cl. CPC G06Q 30/04; G06Q 30/0609; H04L 67/10; G06Q 20/123; G06Q 20/0855

(57) ABSTRACT

Many software vendors offer their software via online service platforms. In one embodiment of a software services distribution system, a cloud services broker is used. A cloud services broker is an organization that acts as an intermediary between subscribers/end users and SaaS vendors. Billing in a cloud services broker system is managed through the cloud services broker because the cloud services broker is the only entity capable of managing the many relationships in such a software distribution system. However, revenue matching and settlement may be problematic. For example, the complexities of billing in a cloud broker system arise because of the intermingling of the types of SaaS vendors, the influence of resellers, and the various billing schemes offered by each of these entities. Implementing such a billing scheme must account for the variations in billing rules and billing schemes from the entities throughout the hierarchy (i.e. SaaS vendors, resellers, sub-resellers, etc.). Furthermore, there may be a disparity between billing rules from upstream entities (e.g. SaaS vendors) and downstream entities (e.g. resellers), whereby billing imposed on subscriber end users based on one particular entity billing scheme is inappropriate. The present disclosure relates to an improved system and method for matching revenue streams in a cloud service broker platform.

### PRIORITY

This utility patent application is a continuation-in-part of U.S. application Ser. No. 15/857,305, filed Dec. 28, 2017, which claims priority to U.S. Provisional Patent Application No. 62/439,619, filed Dec. 28, 2016, all of which applications are incorporated by reference herein.

### TECHNICAL FIELD

This disclosure relates to a system and method of billing, and more particularly, to a system and method for matching revenue streams in a cloud service broker platform.

### BACKGROUND

Currently, many software vendors offer their software via online service platforms. Such software as a service (SaaS) platforms, allow SaaS subscribers/end users to obtain and use software services that are hosted by the SaaS provider. SaaS, also referred to as “on-demand software,” is usually priced on a pay-per-use basis, or using a subscription fee. For example, a SaaS subscriber can pay a monthly (or yearly) subscription fee to the SaaS vendor for access to the SaaS platform for a particular time period (e.g. for a month). Conversely, in a pay-per-use scheme, a SaaS subscriber pays the SaaS provider based on the subscriber's usage of the SaaS platform, within a given period. For example, a subscriber may be charged based on a rate per usage, the usage being metered based on one or more resources within the SaaS platform. In these “subscriber-vendor” schemes, billing between a subscriber and a SaaS vendor is a one-to-one relationship wherein the SaaS vendor's costs are passed directly to the subscriber, which the subscriber will then pay to ensure continued access to the SaaS platform.

In an alternate system of software services distribution, a cloud services broker is used. A cloud services broker is an organization that acts as an intermediary between subscribers/end users and SaaS vendors. A cloud services broker may integrate different software services (available from various SaaS vendors) to present a unified set of services (i.e. a cloud services package) to a subscriber. In some situations, the cloud services broker also hosts the software services and operates in the stead of a traditional SaaS vendor. Additionally, the cloud services broker allows for the provisioning and selling of subscriptions to a variety of SaaS vendors at different levels, resulting in a hierarchical system of downstream resellers. These resellers can subsequently re-sell services to sub-resellers and end-users. In some situations, these re-sellers may price the SaaS offerings at different pricing schemes compared to the SaaS vendors and/or the cloud brokers.

Billing in a cloud services broker system is managed through the cloud services broker because the cloud services broker is the only entity capable of managing the many relationships in such a software distribution system. However, revenue matching and settlement may be problematic. For example, the complexities of billing in a cloud broker system arise because of the intermingling of the types of SaaS vendors, the influence of resellers, and the various billing schemes offered by each of these entities. For example, a cloud services package may include a plurality of software services from a plurality of SaaS vendors. The each of these pluralities of software services in the cloud services package may include various billing schemes (e.g. a combination of usage based and subscription based schemes, and each with varying incentives and billing attributes). Furthermore, downstream resellers may offer their own unique pricing schemes for the cloud services package.

When subscriber end users obtain software services from the cloud services broker, or a downstream reseller, billing for these subscriber end users is not a one-to-one relationship like in the traditional “subscriber-vendor” scheme. Instead, subscriber end users in the cloud services broker scheme may be billed based on different pricing within the layers of the cloud services brokerage distribution channel. Therefore, implementing such a billing scheme must account for the variations in billing rules and billing schemes from the entities throughout the hierarchy (i.e. SaaS vendors, resellers, sub-resellers, etc.). Furthermore, there may be a disparity between billing rules from upstream entities (e.g. SaaS vendors) and downstream entities (e.g. resellers), whereby billing imposed on subscriber end users based on one particular entity billing scheme is inappropriate. For example, fixed markups and discounts may be applied by upstream entities (e.g. SaaS vendors), which markups and discounts may not be appropriate for downstream entities (e.g. end users of resellers). Similarly if the same billing rules are applied on each level of the software distribution system, it would result in non-flexible contracts and rules of software services distribution. Additionally, there is an inability to customize pricing (and the corresponding billing rules) based on the specific types of entities in the distribution channel. For example, a direct subscriber end user may be charged differently than an indirect subscriber end user. This results in lost revenues across different elements of the software distribution system. Lastly, there is also the inability to perform wholesale purchases of services to be distributed following different billing rules, which also result in lost opportunity of larger service distributors.

Therefore, there is a need for an improved system and method for matching revenue streams in a cloud service broker platform.

### SUMMARY

In at least one embodiment of the present disclosure, a system for matching revenue streams in a cloud service broker platform is provided. The system includes service vendors, a cloud broker, resellers at different hierarchical levels such as first resellers, second resellers, and third resellers. The system further includes end customers where the end customers may receive services directly from the service vendors, or indirectly via resellers

In at least one embodiment of the present disclosure, the system for matching revenue streams in a cloud service broker platform includes a marketplace, a service provider database (vendor contract catalogue), a partner database, a marketplace broker, an optional federated connector, a transaction mediator, a usage database, a provisioning database, a connector, a scheduler, and network.

In at least one embodiment of the present disclosure, the marketplace broker is configured to manage the contracts established between the various entities in the system.

In at least one embodiment of the present disclosure, the marketplace broker is configured to store a catalog of available services, configured to monitor the billing usage of the connector, and includes the federated connector (optionally).

In at least one embodiment of the present disclosure, the marketplace broker is configured to sell services via the marketplace to partners.

In at least one embodiment of the present disclosure, the marketplace further includes a transaction mediator configured to store the billing information about all transactions going through the system. The marketplace is further configured to store reconciliation-specific details about all transactions going through the system

In at least one embodiment of the present disclosure, the cloud broker may be operated by a partner, the partner operating to offer the service of the service vendor, to a subscriber.

In at least one embodiment of the present disclosure, the cloud broker is also configured to maintain a hierarchy of resellers and sub-resellers.

In at least one embodiment of the present disclosure, the cloud broker and the marketplace broker may operate as a singular entity.

In at least one embodiment of the present disclosure, a method for matching revenue and cost streams in a cloud service broker platform is provided. The method includes determining transactions, as applied over billing periods, initiating a transaction, whereby the subscriber's billing cycle is updated or initiated based on the transaction attributes, calculating billing period costs, determining contracts between a service vendor and a cloud broker, and calculating the broker cost of sales for each period.

In at least one embodiment of the present disclosure, the method includes maintaining records of the contracts and subscriptions for each service vendor, and calculating the each of the individual costs of the services during particular billing periods.

In at least one embodiment of the present disclosure, the method includes calculating costs at the each of the service vendor, calculating service costs at the cloud broker, calculating costs at the resellers, and generating a consolidated invoice for end customer(s).

In at least one embodiment of the present disclosure, costs are calculated for the each of the service vendor, the cloud broker, the resellers, and a consolidated invoice is generated for end customer(s)

In at least one embodiment of the present disclosure, the method includes reporting attributes of a provisioning operation to the transaction mediator, storing the data in the service usage database, requesting the service usage report for reconciliation with the service vendor, receiving billing rules of service vendor, calculating the total usage of the service, sending the report to the federated connector, transmitting the report to the marketplace broker, applying the pricing model of the service vendor to create a usage report for reconciliation with the service vendor, requesting the service usage report for partner invoicing, receiving billing rules from the partner's subscription, calculating the total usage of the service, sending the report to the federated connector, transmitting the report to the marketplace broker, applying the pricing model from the partner, and invoicing the partner.

In at least one embodiment of the present disclosure, the method further includes reporting attributes of a provisioning operation to transaction mediator, storing the data in the service usage database, initiating estimation of cost of sales per service SKU, implementing billing rules of service vendor, calculating cost of sales per service SKU, reporting cost of sales per service SKU to ERP system.

### DESCRIPTION OF DRAWINGS

FIG. 1 displays a schematic drawing of a system for matching revenue streams in a cloud service broker platform, according to one embodiment.

FIG. 1A displays a schematic drawing of a system for matching revenue streams in a cloud service broker platform, according to one embodiment.

FIG. 1B displays a schematic drawing of a system for matching revenue streams in a cloud service broker platform, according to one embodiment.

FIG. 2 displays a schematic drawing of a system for matching revenue streams in a cloud service broker platform, according to one embodiment.

FIG. 2A displays a flowchart and components of a method for matching revenue streams in a cloud service broker platform, according to one embodiment.

FIG. 2B displays a flowchart and components of a method for matching revenue streams in a cloud service broker platform, according to one embodiment.

FIG. 2C displays a flowchart and components of a method for matching revenue streams in a cloud service broker platform, according to one embodiment.

FIG. 3 displays a flowchart and components of a method for matching revenue streams in a cloud service broker platform, according to one embodiment.

FIG. 4 displays a flowchart and components of a method for matching revenue streams in a cloud service broker platform, according to one embodiment.

FIG. 5 displays a flowchart and components of a method for matching revenue streams in a cloud service broker platform, according to one embodiment.

FIG. 6 displays a method for matching revenue streams in a cloud service broker platform, according to one embodiment.

FIG. 7A displays a schematic drawing of a system for matching revenue streams in a cloud service broker platform, according to one embodiment.

FIG. 7B displays a schematic drawing of a system for matching revenue streams in a cloud service broker platform, according to one embodiment.

FIG. 8 displays the components of a system for matching revenue streams in a cloud service broker platform, according to one embodiment.

FIG. 9 displays the components of a system for matching revenue streams in a cloud service broker platform, according to one embodiment.

FIG. 10 displays a method for matching revenue streams in a cloud service broker platform, according to one embodiment.

FIG. 10A displays a method for matching revenue streams in a cloud service broker platform, according to one embodiment.

FIG. 10B displays a method for matching revenue streams in a cloud service broker platform.

FIG. 10C displays a method for matching revenue streams in a cloud service broker platform, according to one embodiment.

FIG. 11 displays a method for matching revenue streams in a cloud service broker platform, according to one embodiment.

FIG. 12 displays a method for matching revenue streams in a cloud service broker platform, according to one embodiment.

FIG. 13 displays a method for matching revenue streams in a cloud service broker platform, according to one embodiment.

### DETAILED DESCRIPTION

Reference will now be made in detail to the preferred embodiments of the present disclosure, examples of which are illustrated in the accompanying drawings. Additional features and advantages of the disclosure will be set forth in the description that follows, and will be apparent from the description, or may be learned by practice of the disclosure. It is to be understood that both the foregoing general description and the following detailed description are exemplary and explanatory and are intended to provide further explanation of the disclosure as claimed.

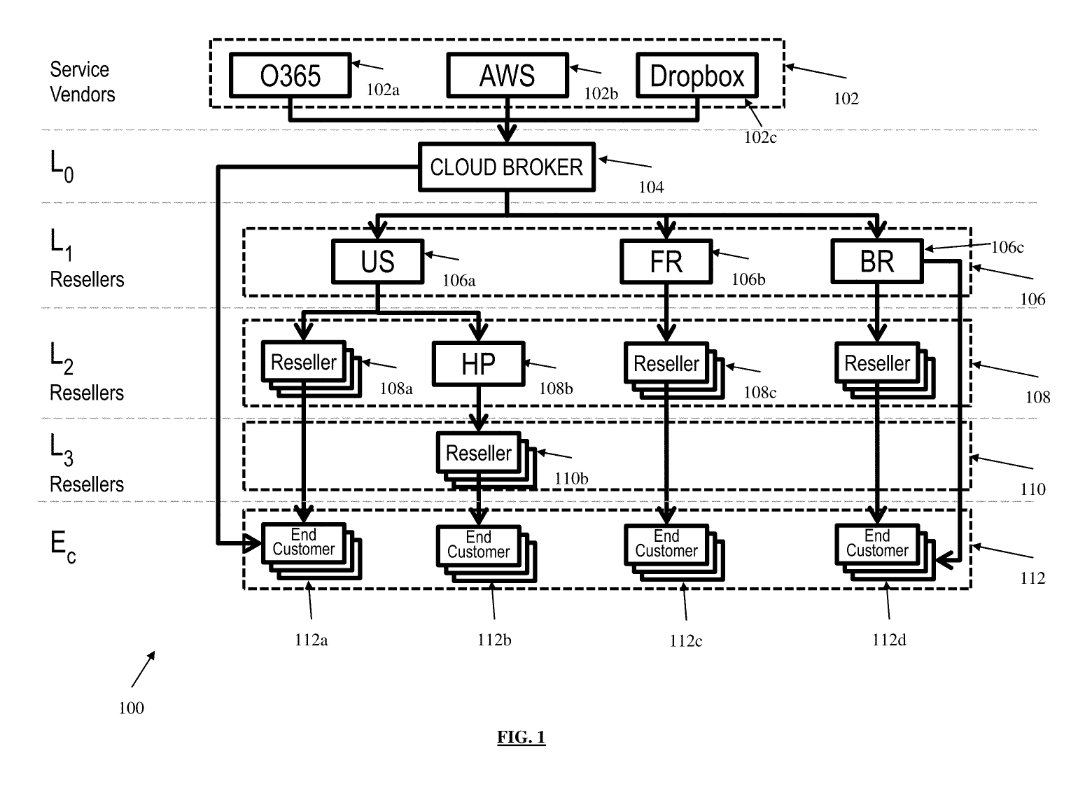

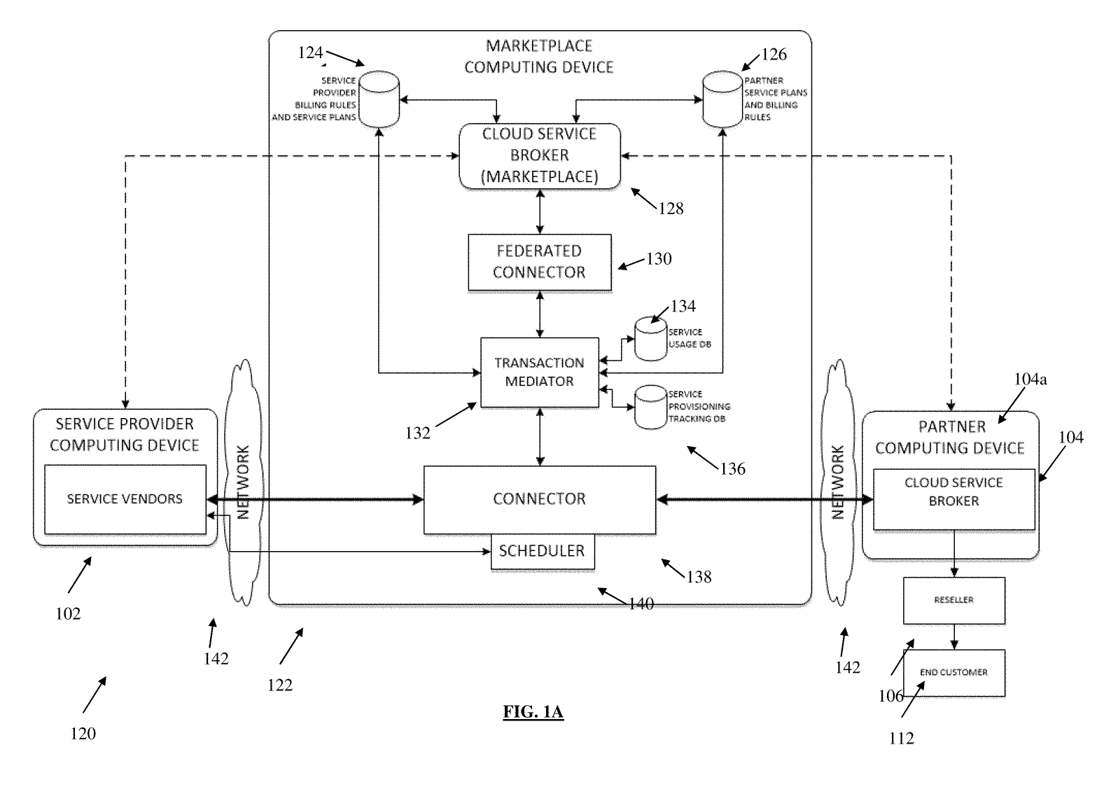

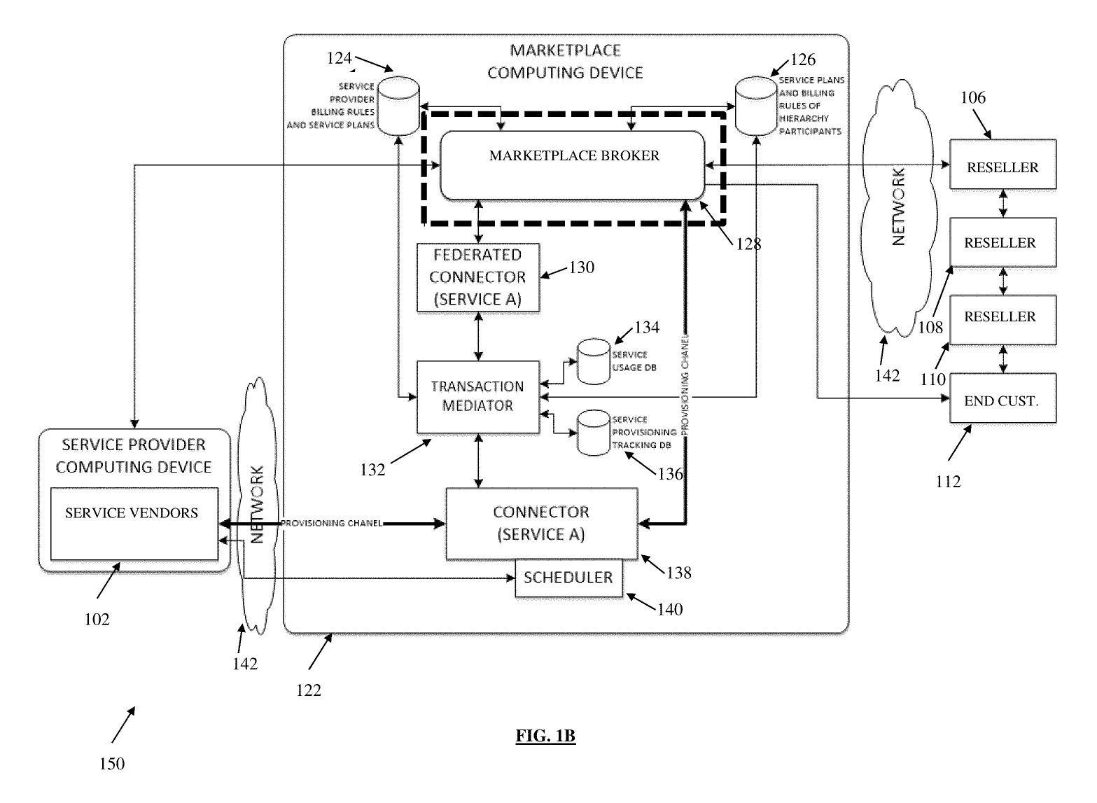

Referring now to FIG. 1, it is shown a system for cloud service distribution via cloud service broker, generally indicated at 100. The system 100 includes service vendor(s) 102, a cloud broker 104, first resellers 106, second resellers 108, third resellers 110, and end customers 112.

In at least one embodiment of the present disclosure, the service vendor(s) 102 are entities that provide service subscriptions to its clients (e.g. business enterprises or customers of different size). For clarity, service vendor(s) 102 may also be referred to as “service providers,” and it shall be understood that both terms may be used interchangeably. Additionally, the service vendor(s) 102 can provide subscriptions to applications and services located on the independent software vendors' hosting servers (not shown). The service vendor(s) 102 can further host services that are subscribed to by customers. Service vendors 102 may be software development companies that develop, support and run services (usually on their own cloud infrastructures). The service vendor(s) 102 also sells and provides subscriptions to their services. It will be appreciated that the service vendor(s) 102 provides an application programming interface (API) for each of its services. The API may include a set of classes, procedures, functions, structures and constants provided by the service vendor(s) 102 for use in external applications. The service vendor(s) 102 may include a plurality of service vendors (e.g. service vendor(s) 102a, 102b, and 102c), such as, for example, Dropbox®, Amazon® Web Services, and Office 365®. The each of the plurality of service vendor(s) 102 offer various software services, such as, email, web hosting, file sharing and storage, networks, telephony, messaging, video conference, general communication, enterprise resource planning (ERP), customer relationship management (CRM), supply chain management, to name a few, non-limiting examples. It will be appreciated that the service vendor(s) 102 may offer their services to resellers or to end customers directly.

In at least one embodiment of the present disclosure, the service vendor(s) 102 is configured to monitor usage of their services by resellers and end customers. For example, service vendor(s) 102a (Office 365®) may be configured to monitor the compute resource usage caused by a subscriber's use of the service vendor(s) 102a's service. It will be appreciated that the compute resources can include at least one metered metric selected from a group consisting of one or more compute resources used on a per time basis, one or more read and write I/O operations, and network bandwidth usage, to name a few, non-limiting examples. It will be further appreciated that the metering usage can be conducted at one or more of an application programming interface (API). It will also be appreciated that the metrics obtained from such monitoring may be stored in the service vendor(s) 102's environment, or can be transmitted to other entities in the system 100, such as, for example, via the Internet.

It will be appreciated that the service vendor(s) 102 may be configured to apply their own billing rules. For example, the service vendor(s) 102b (e.g. Amazon® Web Services), may apply a flat rate, monthly pricing structure, while service vendor(s) 102c (e.g. Dropbox®) may apply a rate commensurate with usage of compute resources. It will be further appreciated that the service vendor(s) 102 may transmit billing rules to other entities in the system 100.

In at least one embodiment of the present disclosure, the system 100 further includes a cloud broker 104. A cloud broker 104 is an entity which integrates different software services (e.g. from service vendor(s) 102) via an API and provides functionality of provisioning, and selling subscriptions to the services of the service vendor(s) 102, to a variety of other entities (e.g. resellers and end customers). It will be appreciated that the cloud broker 104 provides user interfaces for different types of service vendor(s) 102. For example, a service vendor that provides communications service (e.g. email), will have a different interface than a hosting or storage service vendor (e.g. Dropbox). It will be further appreciated that provision of different interfaces supports a hierarchical system of resellers, as further disclosed herein.

In at least one embodiment of the present disclosure, the system 100 further includes resellers at different hierarchical levels. For example, first resellers 106 may be geographically based resellers (e.g. first reseller 106a serves the U.S., first reseller 106b serves France, and first reseller 106c serves Brazil). The system 100 may further include downstream resellers, such as second resellers 108, and third resellers 110. The resellers may be organized based on any factor, such as geographic distribution, industry verticals, consumer verticals, or technology verticals, to name a few non-limiting examples. Although only a select number of resellers and downstream resellers are shown, it will be appreciated that the system 100 may include any number of resellers, and downstream resellers, connected by software and hardware systems of a type well known in the art (e.g. the Internet), which collectively are operable to perform the functions delegated to the resellers according to the present disclosure.

In at least one embodiment of the present disclosure, the system 100 further includes end customers 112. The end customers 112 may include individuals or enterprise organizations that are subscribing to services offered by the service vendor(s) 102 (or those that may at least originate from service vendor(s) 102). It will be appreciated that the end customers 102 may receive services directly from the service vendor(s) 102, or indirectly via resellers. For example, referring to FIG. 1, end customer(s) 112a may receive services from second reseller 108a, wherein second reseller 108a is a downstream reseller for first reseller 106a. Similarly, end customer(s) 112b may receive services from third reseller 110b, wherein third reseller 110b is a downstream reseller of second reseller 108b, and further wherein second reseller 108b is a downstream reseller of first reseller 106a. It will be appreciated that each of the resellers is configured to use their own billing and pricing schemes, such that each of the end customers 112 may receive different pricing and billing terms even if they subscribe to the same services from the service vendor(s) 102.

Referring now to FIG. 1A, it is shown a system for matching revenue streams in a cloud service broker platform, generally indicated at 120. The system 120 includes a marketplace 122, a service provider database 124, a partner database 126, a marketplace broker 128, a federated connector 130, a transaction mediator 132, a usage database 134, a provisioning database 136, a connector 138, a scheduler 140, and network 142.

In at least one embodiment of the present disclosure, the service provider database 124, the partner database 126, the usage database 134, and provisioning database 136 store information generated by the system 120 and/or retrieved from one or more information sources. In at least one embodiment of the present disclosure, the service provider database 124, and the partner database 126, can be “associated with” the marketplace broker 128, and the usage database 134, and provisioning database 136 can be “associated with” transaction mediator 132, as shown in the embodiment in FIG. 1A. The each of the service provider database 124, the partner database 126, the usage database 134, and provisioning database 136 can also be “associated with” a server or computing device remote from the marketplace 122, provided that the remote server or computing device is capable of bi-directional data transfer with marketplace 122, such as, for example, in Amazon AWS, Rackspace, or other virtual infrastructure, or any business network. In at least one embodiment of the present disclosure, the marketplace 122 upon which the each of the service provider database 124, the partner database 126, the usage database 134, and provisioning database 136 reside, is electronically connected to marketplace 122 (for example, via network 142), and the components therein such that they are capable of continuous bi-directional data transfer with each other.

For purposes of clarity, the each of the service provider database 124, the partner database 126, the usage database 134, and provisioning database 136 are shown in FIG. 1A, and referred to as single databases. It will be appreciated by those of ordinary skill in the art that the each of the service provider database 124, the partner database 126, the usage database 134, and provisioning database 136 may comprise a plurality of databases connected by software systems of a type well known in the art, which collectively are operable to perform the functions delegated to the each of the service provider database 124, the partner database 126, the usage database 134, and provisioning database 136 according to the present disclosure. The each of the service provider database 124, the partner database 126, the usage database 134, and provisioning database 136 may also be part of distributed data architecture, such as, for example, a Hadoop architecture, for big data services. The each of the service provider database 124, the partner database 126, the usage database 134, and provisioning database 136 may comprise relational database architecture, noSQL, OLAP, or other database architecture of a type known in the database art. The each of the service provider database 124, the partner database 126, the usage database 134, and provisioning database 136 may comprise one of many well-known database management systems, such as, for example, MICROSOFT's SQL Server, MICROSOFT's ACCESS, MongoDB, Redis. Hadoop, or IBM's DB2 database management systems, or the database management systems available from ORACLE or SYBASE. Each of the service provider database 124, the partner database 126, the usage database 134, and provisioning database 136 retrievably stores information that is communicated to it, as further disclosed herein.

In at least one embodiment of the present disclosure, the marketplace broker 128 is configured to manage the contracts established between the various entities in the system 100 (e.g. service vendor(s) 102, cloud broker 104, first resellers 106, end customers 112, etc.). For example, every subscription to a service offered by any of the plurality of service vendor(s) 102 is governed by a contract, wherein the contract memorializes the terms of the service such as pricing, licensing costs, and service level agreements, to name a few non-limiting examples. Similarly, resellers (e.g. first resellers 106) may have additional (or different) contract terms wherein an end customer 112's receipt of service is governed by the terms of the reseller contract, as opposed to the terms of the service vendor's contract. In such an exemplary embodiment, the possibility to provision, sell and modify a particular service is managed by the applicable contract terms of the service vendor(s) 102.

In at least one embodiment of the present disclosure, the marketplace broker 128 is configured to store a catalog of available services (i.e. the services offered by service vendors or resellers). A service offered by service vendor(s) 102 is considered ‘available’ when the service vendor(s) 102 has a contract with the marketplace 122. In the process of assigning a contract, the service providers 102 may provide service plans, billing rules for each service (e.g. an SKU, as further disclosed herein) and a connector (e.g. connector 138) to the marketplace 122. The service vendor(s) 102's plans and billing rules are stored in the service provider database 124.

In at least one embodiment of the present disclosure, the marketplace broker 128 is further configured to monitor the billing usage of the connector 138. For example, partner 104a may be an entity that desires to offer service based on service vendor(s) 102. When the partner 104a creates a new service offering based on the service vendor(s) 102, the partner 104a uses the connector 138 to operably connect to the marketplace 122, such that the services of the service vendors 112 can be contracted for. This may be considered as ‘provisioning.’ For example, referring to FIG. 1A, cloud broker 104 may be operated by the partner 104a, wherein the partner 104a desires to offer the services of service vendor(s) 102. In such an exemplary embodiment, the partner 104a is made ‘available’ via the marketplace 122, via the use of the connector 138 (i.e. the service vendor(s) 102 are made available to the partner 104a via the use of the connector 138). Continuing with this example, the partner 104a may now provide the services to resellers 106 or even end customers 112, after being provisioned.

In at least one embodiment of the present disclosure, the marketplace 122 further includes the federated connector 130, the federated connector 130 configured to receive usage reports based on partner subscription from the transaction mediator 132 (as further disclosed herein). For example, a contract between a marketplace broker and a partner may require that the invoices be sent on the first day of the month, wherein the federated connector 130 sends the requests to the transaction mediator 132 on the first day of the month, to receive the necessary data. Federated connector 130 requests service usage of a particular service (per service SKU) and receive total usage per SKU in service units. As cloud service broker marketplace on the embodiment presented on the FIG. 1A doesn't operate with direct information from service customers about their activity and performed transactions (they buy trough the partner, not via marketplace), cloud service broker marketplace has to extract this information through monitoring of transaction passing via connectors by the instruments of transaction mediator and federated connector.

In at least one embodiment of the present disclosure, the marketplace 122 further includes the connector 138. The connector 138 is configured specifically for every service (for example, a service provided by any of the service vendor(s) 102). For each of the plurality of service vendor(s) 102 (for example, as shown in FIG. 1), the connector 138 is configured to distinguish one subscription from another as further disclosed herein. The connector 138 is configured to identify the source of the service (i.e. the identity of the service vendor(s) 102) and the destination of the service (e.g. the identity of end customers 112). It will be appreciated that the connector 138 may also receive information about the services during the provisioning of the services. In at least one embodiment of the present disclosure, the connector 138 is configured to define a partner 104a and its subscriptions because the connector 138 is deployed on a per partner subscription basis. It will be appreciated that any tenant (e.g. end customers 112) and end-user IDs are generated by cloud broker 104, and a subscription ID is generated by service vendor(s) 102, when the each of the plurality of service vendor(s) 102 confirms to the connector 138 that provisioning has been successfully completed. It will be further appreciated that although a single connector 138 is shown, the system 120 may include as many connector 138s as needed to support the each of the plurality of service vendor(s) 102. For example, if marketplace broker 128 purchased N subscriptions for N different services, the marketplace 122 may provide N connector 138 instances for the each of the N different services.

In at least one embodiment of the present disclosure, the marketplace broker 128 is configured to sell services via the marketplace 122 to partners (e.g. partner 104a) in accordance with service plans for that particular partner. It will be appreciated that for each sale of a partner's services, the marketplace broker 128 sends a request to a connector hub (not shown, but as disclosed in U.S. application Ser. No. 15/005,151, for PROVISIONING APPLICATIONS USING A CONNECTORS HUB SERVICE, which application is incorporated in its entirety by reference herein) to deploy a connector instance (e.g. connector 138) for the partner (e.g. partner 104a) to operably connect with the marketplace 122, and to tune the provisional channel. At the same time, the marketplace broker 128 provides billing service to the partner via the federated connector 130 and transaction mediator 132. It will be appreciated that the marketplace broker 128 operates in the same manner as the cloud broker 104 but that the cloud broker 104 provides the channel to sell software as a service, while marketplace broker 128 provides the mechanism to provision the service that will be eventually sold as a service.

In at least one embodiment of the present disclosure, the connector 138 is operably connected to the transaction mediator 132, for example, when provisioning of a service is accomplished. The connector 138 is further configured to report to the transaction mediator 132, wherein the report includes, a date of activation, provisioning, cancellation, change, service ID (as further disclosed herein), identification of a cloud service broker, the number of services, markers of actions such as activation, change and cancellation, to name a few non-limiting examples. It will be further appreciated that the connector 138 may report ID's of entities within a hierarchical billing system. For example, entities may include first resellers 106, second resellers 108, third resellers 110, and end customers 112. The connector 138 further operates to perform analysis of the activities by the transaction mediator 132.

In at least one embodiment of the present disclosure, the system 120 further includes a scheduler 140 that is operably connected to the connector 138. It will be appreciated that in an exemplary embodiment selling services include disk space, CPU-time (pay-as you go services). The scheduler 140 is configured to provide tracking of resource usage (e.g. disk space usage, CPU-time), by sending periodic requests to the applicable service vendor(s) 102, to retrieve such information. The scheduler 140 is further configured to transmit resource usage information to the transaction mediator 132 as needed, or periodically.

In at least one embodiment of the present disclosure, the marketplace 122 further includes a transaction mediator 132. A transaction mediator 132 is configured to store the billing information about all transactions going through the system 120. For example, a transaction between end customer(s) 112 and service vendor(s) 102a, may be of a type such as a purchase of software from the service vendor(s) 102a, an upgrade of the software and/or services from the service vendor(s) 102a, a downgrade of the software and/or services from the service vendor(s) 102a, a cancellation of the services from the service vendor(s) 102a, or the like. In at least one embodiment of the present disclosure, the transaction mediator 132 is further configured to track a service identifier, the service identifier being an alphanumeric identifier of a resource type related to the transaction. The transaction mediator 132 is further configured to track the unit of measure (UOM) such as for example, the number of units or licenses being used by the subscriber(s) of the service vendor(s) 102. The transaction mediator 132 may also track the quantity and start and end dates of the service usages, as well as receive any metering or monitoring of compute resource usage, and billing rules from the service vendor(s) 102, to name a few, non-limiting examples.

In at least one embodiment of the present disclosure, the marketplace 122 is further configured to store reconciliation-specific details about all transactions going through the system 120, via the transaction mediator 132. For example, each of the plurality of service vendor(s) 102 may have a vendor identifier (ID) associated therewith. The transaction mediator 132 is further configured to collected other identifiers such as, for example, service vendor-side data (e.g. subscription ID); any other unique identifiers; a partner identifier or subscription ID for any resellers or end customers; partner-side data (e.g. end-customer's subscription ID) and order identifier.

It will be appreciated that for every transaction, the transaction mediator 132 must store minimal amount of data required to report (if applicable), the vendors' identity, the resellers' identify, the end customers' identity, the billing rules from the service vendor(s) 102 and the resellers (e.g. first reseller 106, second reseller 108, third reseller 110), and usage and pricing for the each entity in the system 100.

In at least one embodiment of the present disclosure, the cloud broker 104 may be operated by partner 104a, the partner 104a operating to offer the service of the service vendor(s) 102, to a subscriber. It will be appreciated that the cloud broker 104 is further configured to receive usage information of all tracked resource types by request, and aggregated by resource type and prorated according to terms set forth by the service vendor(s) 102 (or the resellers). Continuing with the previous example, if service vendor(s) 102a (Office 365®) is configured to bill based on compute resource usage caused by a subscriber, the vendor 102a may track this information and the transaction mediator 132 is configured to receive this information.

In at least one embodiment of the present disclosure, the cloud broker 104 is also configured to maintain a hierarchy of resellers and sub-resellers. For example, a cloud broker 104 may serve first resellers 106, second resellers 108, third resellers 110, and end customers 112 (as shown in FIG. 1). In such an exemplary embodiment, the cloud broker 104 is configured to capture and maintain consumption of cloud services by subscribing entities. It will be appreciated that the cloud broker 104 is configured to enable a partner to capture and bill usage of subscriber (e.g. end customers 112), while marketplace broker 128 may operate to bill the partner for usage of the connector 138.

It will be appreciated that the transaction mediator 132 is further configured with a software agent to record transactions, indicative of individual billable provisioning operations of a cloud service, passing between an end customer(s) 112 and service vendor(s) 102. In at least one embodiment of the present disclosure, the information pertinent to the transactions is then processed and passed on to a central system (e.g. marketplace 122) where it could be extracted for billing purposes. It will be further appreciated that by monitoring the provisioning flow, the cloud broker 104 can provide real time billing information without the need to rely on the same billing rules imposed by service vendor(s) 102's data.

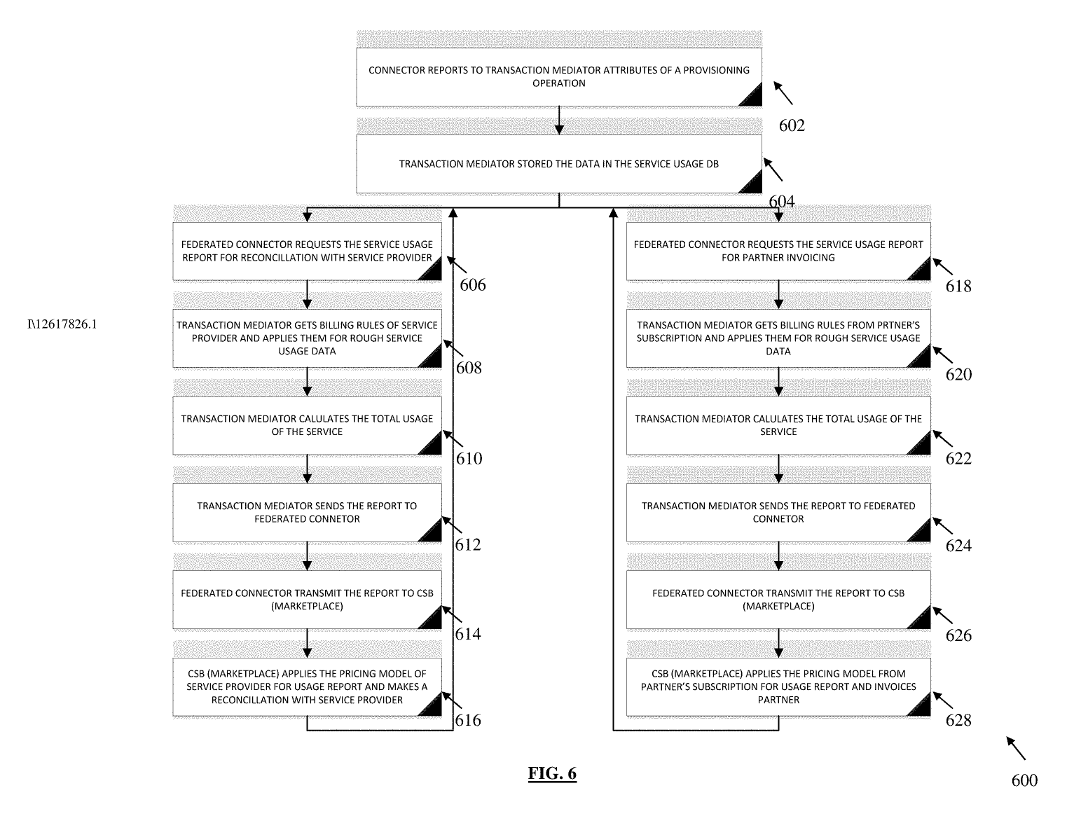

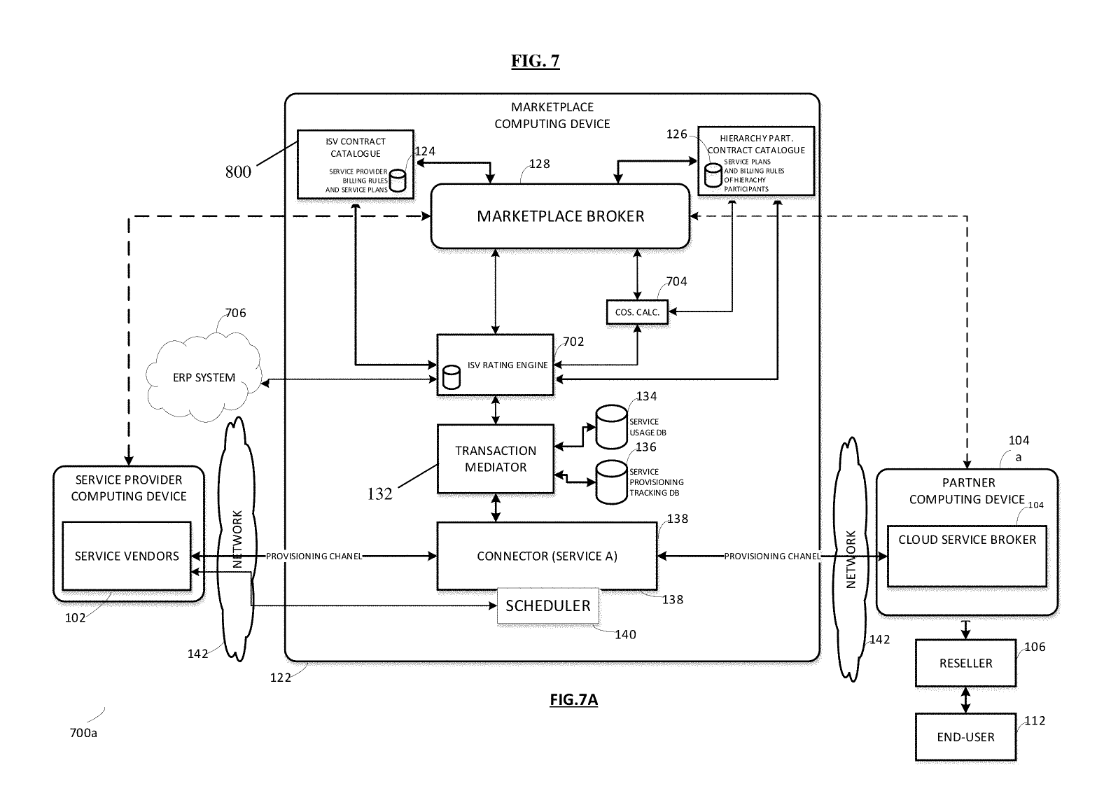

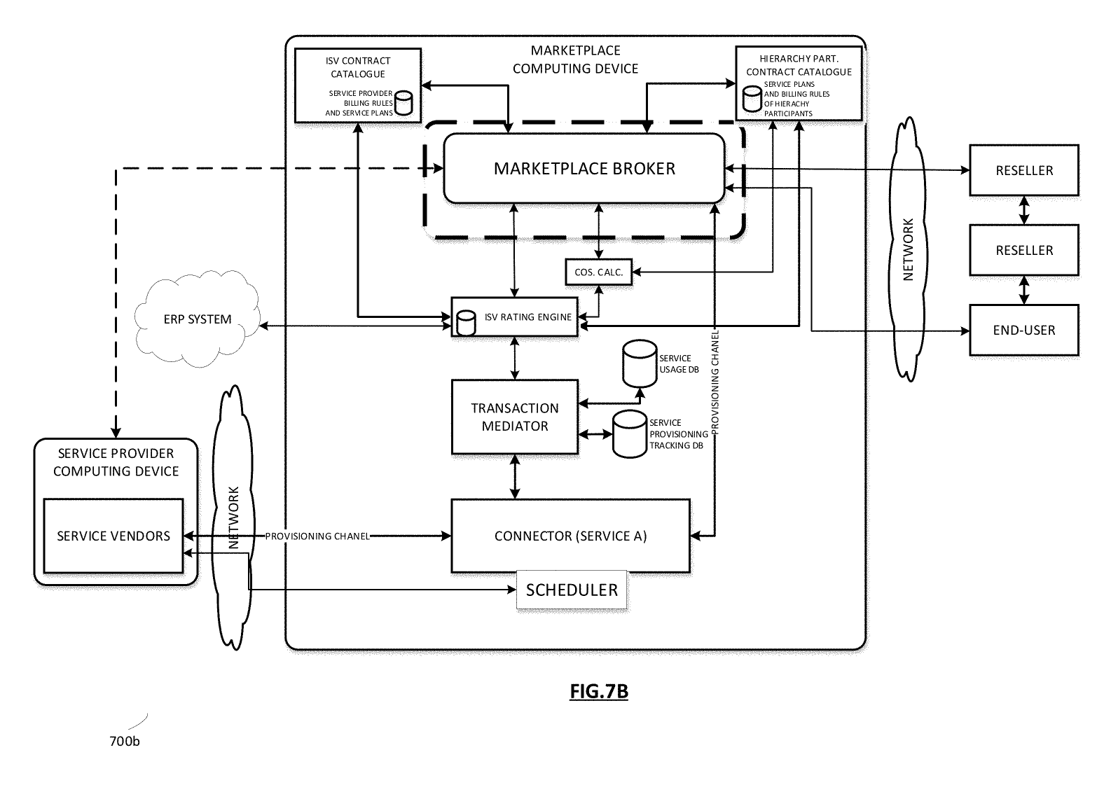

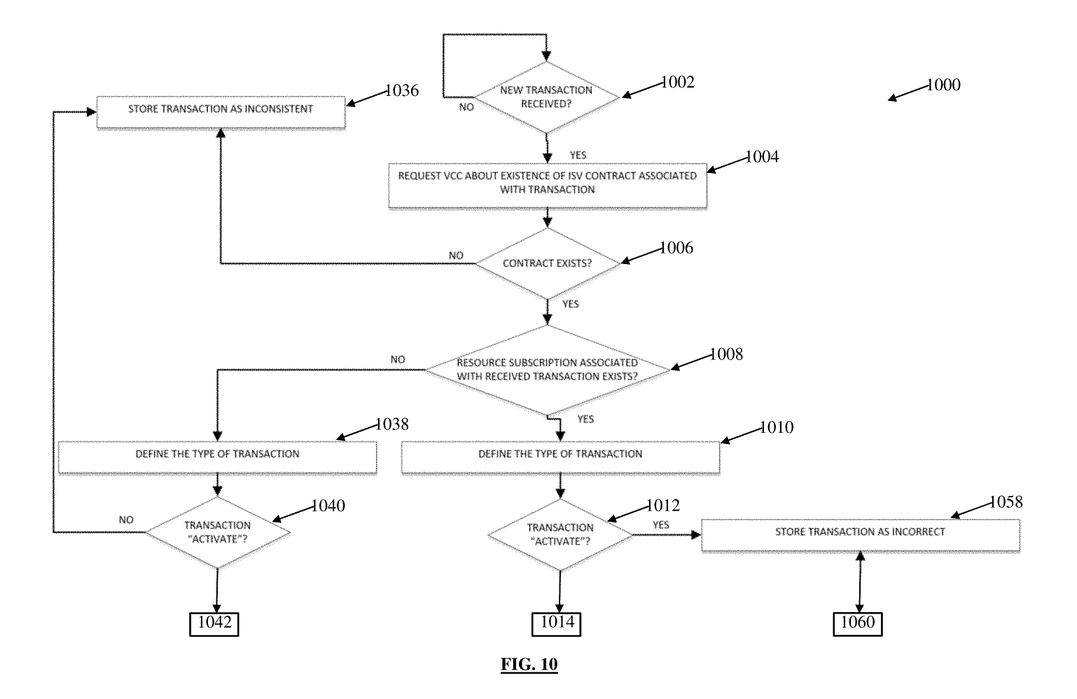

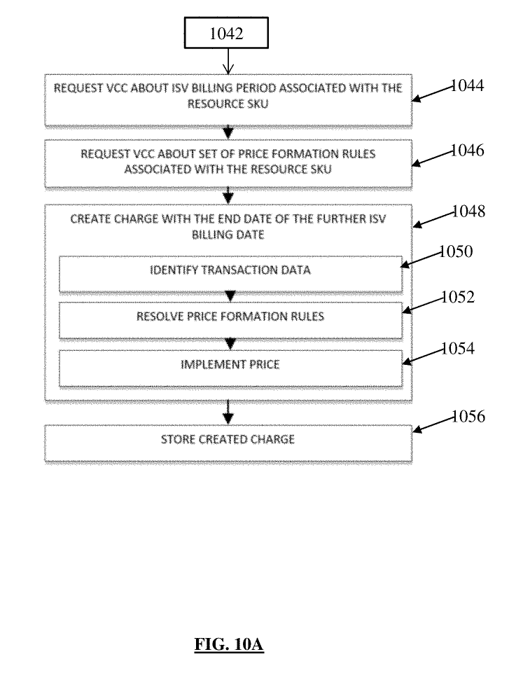

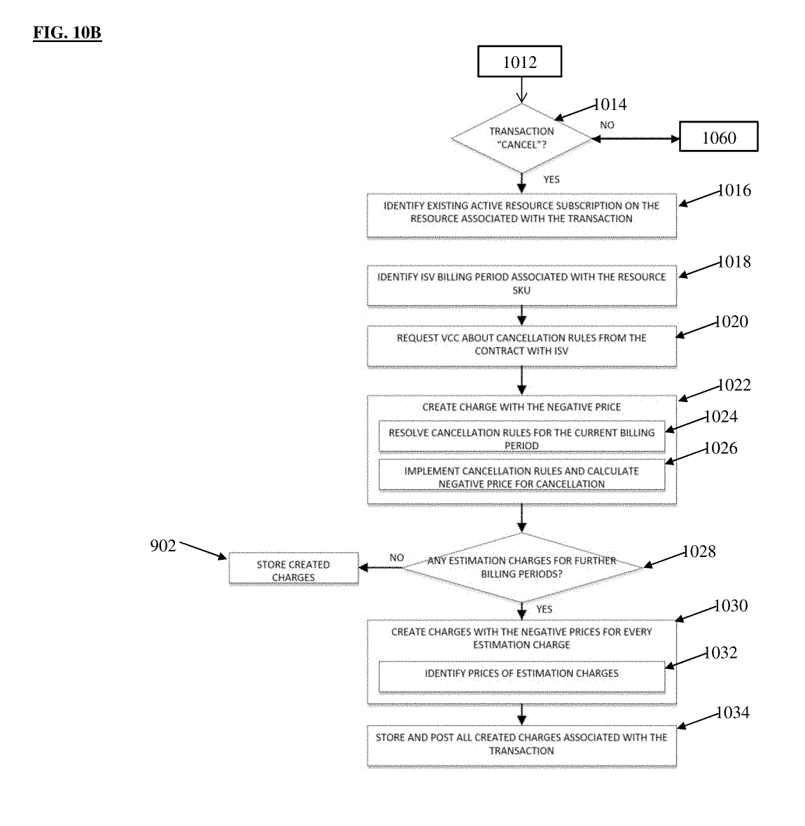

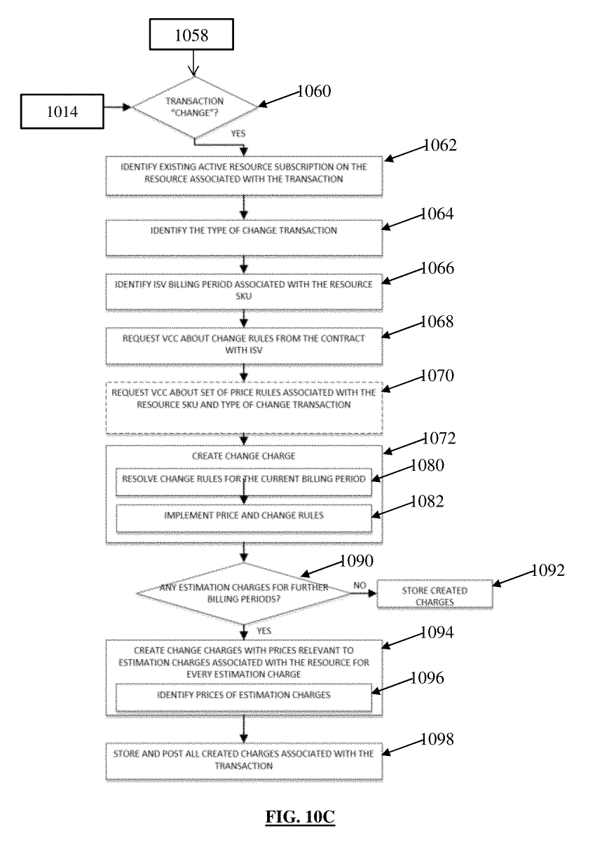

It will be appreciated that revenue matching and settlement operates to balance costs and revenue between the marketplace and vendors. For example, the marketplace broker is billed by vendors and generates costs. In at least one embodiment, the partner is billed by the marketplace broker per transaction via connector. In at least one embodiment, the latter generates a revenue stream, whereby the transaction mediator collects all data about transactions moving across connector, and the marketplace broker can estimate cost of sales per each service (SKU). It will be further appreciated that the marketplace broker has all needed data for this. Marketplace implements price conditions and approximate Vendors' billing rules on Partner transactions and report it to internal or external ERP system for accounting purposes. More detailed and updated system is shown on FIG. 7A and detailed method on—FIG. 10-13.

In at least one embodiment of the present disclosure, the cloud broker 104 and the marketplace broker 128 may operate as a singular entity, as shown at system 150, in FIG. 1B. It will be appreciated that the marketplace broker 128 can perform the same function as the cloud broker 104, as further disclosed herein.

In at least one embodiment of the present disclosure, the system 150 includes a first reseller 106, second reseller 108, third reseller 110, and end customer 112. It will be appreciated that the second reseller 108 may include a sub-reseller, wherein the sub-reseller operates to further resell the services from first reseller 106, as disclosed above. It will be further appreciated that the third reseller 110 may include a tenant subscribing to services from the marketplace broker 128, wherein the tenant operates to use the services. It will be further appreciated that the end customer 112 may be an end user of the tenant (e.g. an employee end user of a company tenant that has subscribed to the services), or an end user of a reseller type entity (e.g. a direct consumer of integrated software services provided by reseller 110).

In at least one embodiment of the present disclosure, the marketplace broker 128 is operably configured to provision the first reseller 106, second reseller 108, third reseller 110, and end customer 112, as needed in order for each party to perform its own billing and pricing rules, as further disclosed herein.

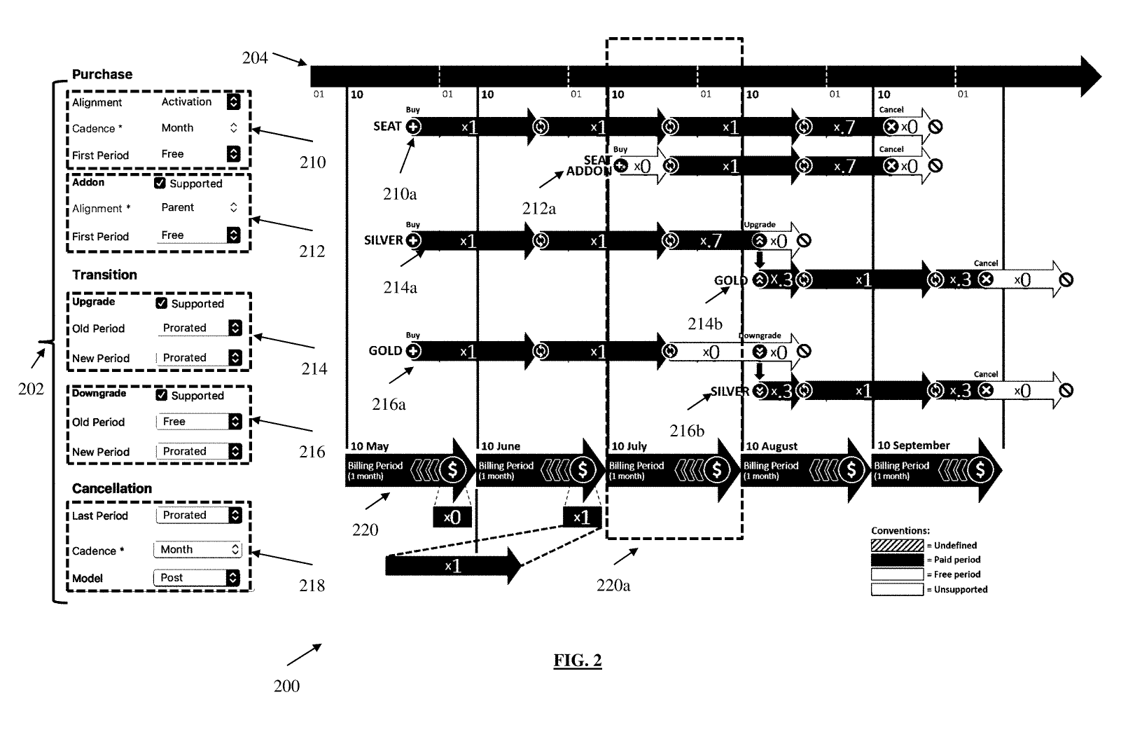

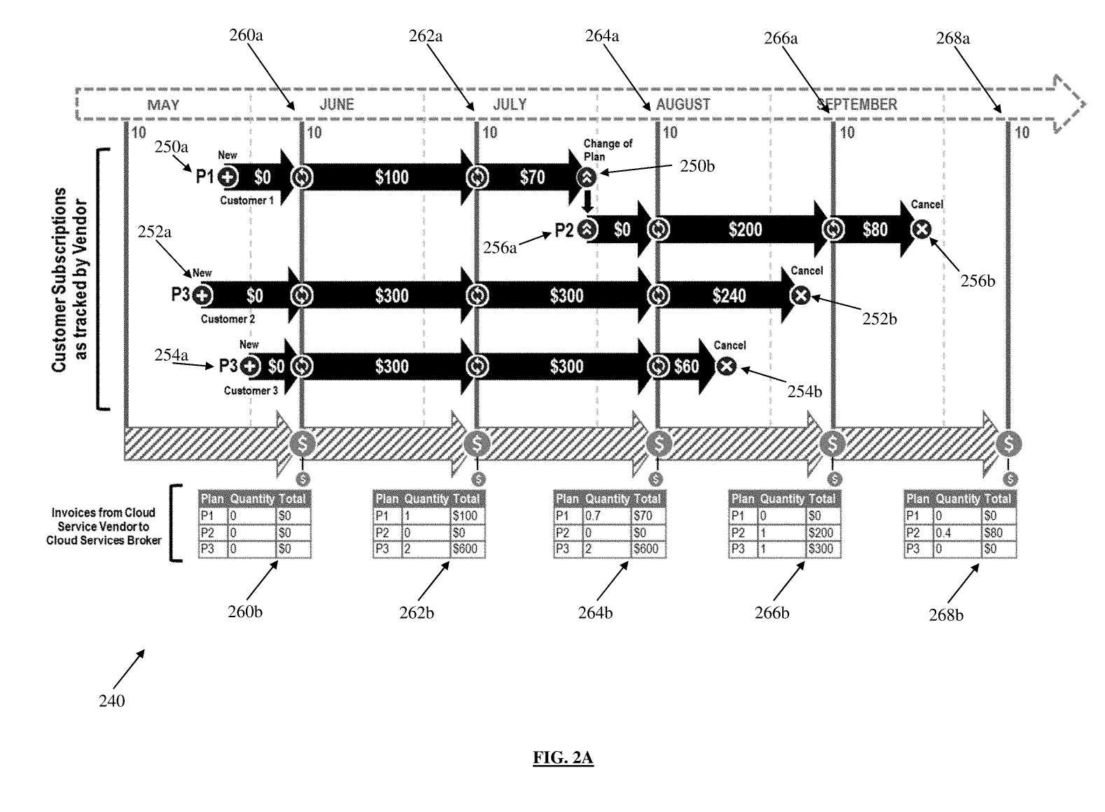

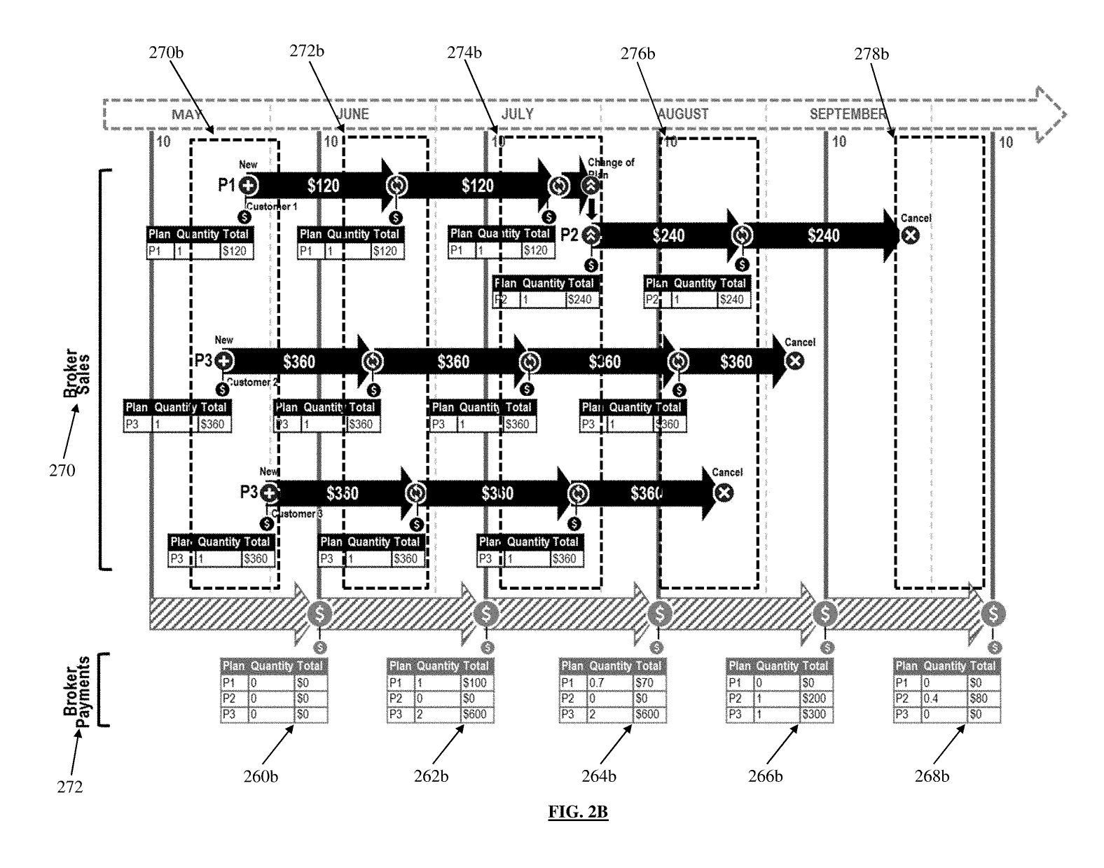

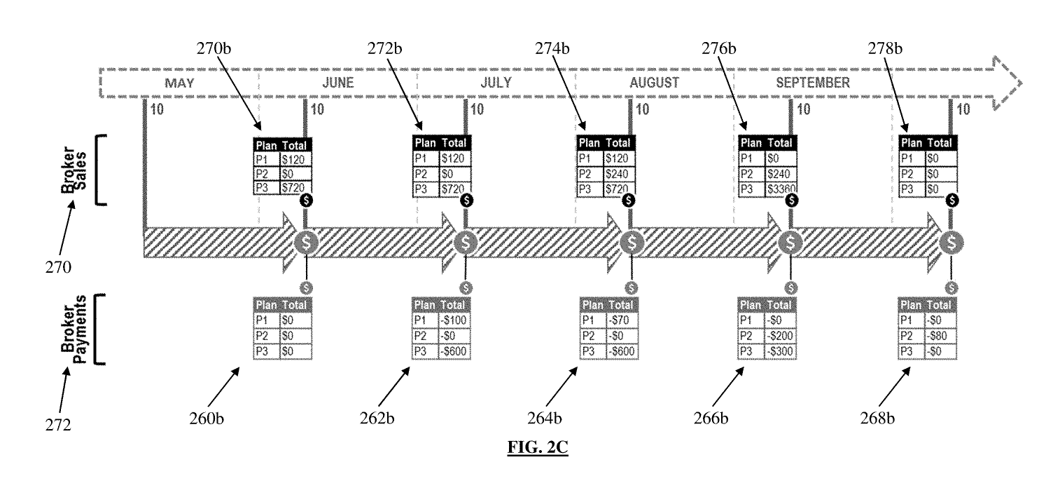

Referring now to FIG. 2, it is shown a flowchart and components of a method for transaction processing in a cloud service broker platform, generally indicated at 200. The flowchart 200 includes transactions 202, as applied over billing periods 204. In at least one embodiment of the present disclosure, the transactions 202 include a purchase 210, an add-on 212, an upgrade 214, a downgrade 216, and a cancellation 218. Although only select transactions are shown, it will nonetheless be appreciated that the transactions 202 may include any type of transactions as would be well known and practiced by one having ordinary skill in matching revenue streams in a cloud service broker platform.

In at least one embodiment of the present disclosure, the each of the transactions 202 may include transaction attributes such as the start of service date, the billing period, and any incentives, to name a few, non-limiting examples. For example, purchase 210 includes a monthly billing period (i.e. the billing period is a month); and, the incentive includes a first month of free service. It will be appreciated that the transaction attributes (also known as billing rules), come from contracts between the various entities (e.g. cloud broker 104, first resellers 106, etc.) in the system 100. It will be further appreciated that other billing rules may be included for the each of the transactions 202, such as, for example, free period, payment in full, proration for purchase and/or cancellation, add-on, upgrade, downgrade, alignment (e.g. the alignment of billing periods between a parent subscription and a child subscription), and anniversary date.

In at least one embodiment of the present disclosure, subscribers (e.g. end customers 112) may initiate a transaction, whereby the subscriber's billing cycle is updated or initiated based on the transaction attributes. For example, purchase 210 is a transaction to purchase a service. The purchase 210's attributes include a monthly cadence (i.e. a monthly billing cycle), with a first month of free service as the incentive. Therefore, in the first billing cycle, (i.e. the first month), the subscriber is not charged with any fees. Similarly, the same subscriber may initiate an add-on 212 after a few months. In such an example, the costs of the add-on 212 are added to the total costs of the subscriber's services. As shown in FIG. 2, subscriber cost 210a is supplemented by subscriber cost 212a in the third month. The add-on 212's attributes show that its billing cycle is aligned with that of the parent (i.e. the purchase 210). Therefore, the add-on 212 will be billed during the same billing cycle as purchase 210. As shown in FIG. 2, add-on 212 includes a free first month as an incentive. It will be appreciated that add-on 212 may have its own alignment attribute such that its billing cycle does not align with that of the parent (i.e. the purchase 210).

In at least one embodiment of the present disclosure, a subscriber may also want to upgrade a service. For example, an upgrade 214 transaction may be initiated (for example, at the marketplace 122), whereby the subscriber cost 214a is modified to the upgraded subscriber cost 214b (as shown in FIG. 2). The upgrade 214 includes attributes of proration during the ‘old’ period, and proration during the ‘new’ period. It will be appreciated that during the billing cycle during which the upgrade 214 is initiated, the transition from subscriber cost 214a to subscriber cost 214b is such that the subscriber's costs are prorated for the monthly billing cycle, on either side of the transition (i.e. the subscriber is prorated based on the subscriber cost 214a from the start of the billing cycle, to before the upgrade; and, is prorated based on subscriber cost 214b from the point of upgrade to the end of the billing cycle).

In at least one embodiment of the present disclosure, a billing period costs 220 is calculated at the end of each billing period, based on the summation of the plurality of costs incurred by the subscriber. For example, during the billing period 220a, and assuming that one subscriber has initiated all the transactions 202, the subscriber's costs may include, the subscriber costs 210a, the subscriber costs 212a, the subscriber costs 214a, subscriber costs 216a (including the transition to a downgrade). It will be appreciated that the billing period 220a's costs is a summation of all the individual services costs incurred by the subscriber. It will be further appreciated that such costs may include a cost per reseller, a cost per end customer, or a cost per service vendor, to name a few non-limiting examples.

Referring now to FIG. 2A, it is shown an example 240, of an exemplary method for matching revenue streams in a cloud service broker platform, according to at least one embodiment of the present disclosure. In the example 240, a contract between a service vendor and a cloud broker is defined wherein a plurality of subscriptions to the service vendor are created (i.e. subscription to plan P1, subscription to plan P2, and subscription to plan P3, and wherein the plan P1 costs $100, the plan P2 costs $200, and the plan P3 costs $300, for each billing period). It will be appreciated that the each of the plurality of subscriptions includes a plurality of billing attributes therewith. In example 240, the each of the plurality of subscriptions has a subscription alignment, wherein the anniversary date falls on the tenth (10^{th}) day of each month (which is the start/end of each billing period for the each of the plurality of subscriptions). Furthermore, the each of the plurality of subscriptions includes a promotion period wherein the service vendor offers a free period until the first anniversary date. The each of the plurality of subscriptions also includes provisions to prorate, and invoice after the end of each billing period. It will be appreciated that the billing attributes for each subscription may depend on the service vendor(s) 102.

Continuing with example 240, a first subscriber (e.g. an end customer 112) may initially subscribe to service plan P1, as shown at 250a; a second subscriber may initially subscribe to a service plan P3, as shown at 252a; and a third subscriber may initially subscribe to service plan P3, as shown at 254a. At the end of the billing cycle, for the each of the subscribers, the service vendor(s) 102 would send a billing invoice to the appropriate cloud broker (e.g. cloud broker 104), as shown at 260b, 262b, 264b, 266b, and 268b. For example, 260b indicates the total costs for subscribing to the plans P1, P2, and P3 during the billing period 260a. In the present example, the costs at 260b are $0 because the each of the plans includes a promotional free period of service that concludes at the first anniversary, as defined above. Similarly, at 262b (the costs for billing period 262a), the cost for plan P1 is $100, the cost for plan P2 is $0, and the cost for plan P3 is $600. It will be appreciated that when service vendor(s) send a billing invoice to the marketplace broker 128, there is a necessity to match costs (i.e. amounts paid to vendors) and revenue (i.e. amounts received form resellers or partners). By using the transaction mediator 132 to track all transactions, the marketplace computing device 122 is configured to simulate the process of vendor's billing by applying vendor's billing rules (which may be stored inside service provider database 12, as further disclosed below). It will be further appreciated that the marketplace broker 128 allows for the reconciliation with the vendor invoices and generate accurate cost-revenue matching.

Continuing with the above example, it is shown in FIG. 2B, contracts between the cloud broker 104 and its subscriber (e.g. end customers 112a, 112b, 112c, 112d), wherein the subscriber enrolls in monthly subscriptions. As shown in FIG. 2B, plan P1 costs $120, plan P2 costs $240, and plan P3 costs $360, for subscriber(s). It will be further appreciated that the attributes applied to the each of the plans includes: a subscriptions alignment wherein the anniversary day falls on the day of purchase; no free period included; no refund for changes in a plan; prorated cancellations; and a prepayment of fees.

Following the billing model shown in FIG. 2B, the broker sales 270 for each period is according to the total amount of sales for the billing period. For example, during period 270b, the total cost for plan P1 is $120, the total cost for plan P2 is $0,and the total cost for plan P3 is $720. Similarly, for the period 272b, the total cost for plan P1 is $120, the total cost for plan P2 is $0, and the total cost for plan P3 is $720. Continuing with this example, for the period 274b, the total cost for plan P1 is $120, the total cost for plan P2 is $240, and the total cost for plan P3 is $720.

In at least one embodiment of the present disclosure, the system 100 is further configured to maintain records of the contracts and subscriptions for each service vendor (e.g. service vendor(s) 102), resellers (e.g. resellers 106), and end customer (e.g. end customers 112). It will be appreciated that this allows each entity in the hierarchy to perform reconciliation and profit and loss analysis. For example, referring to FIG. 2C, it is shown a settlements and reconciliation between cloud broker 104's broker sales 270, and cloud broker's 104's broker payments 272. In this example, the brokers sales in the period 270b for plan P1 is $120, whereas the broker payments during same billing period for plan P1 is $0, as shown an 260b. As shown in FIG. 2C, it will be appreciated that there is a cost-revenue matching between broker sales 270 and broker payments 272 for any billing period.

Referring now to FIG. 3, it is shown a flowchart and components of a method for matching revenue streams in a cloud service broker platform, generally indicated at 300. The flowchart 300 shows services 302, service billing rules attributes 302a, billing periods 310, and monthly amount of services in service units 312. In at least one embodiment of the present disclosure, the each of the services 302 represents a service that has been subscribed to by a subscriber (e.g. end customers 112). It will be appreciated that the services 302 may be received from the cloud broker 104 or from Marketplace Broker 128 depending on provisioning channel architecture, in other words, whether the cloud broker 104 and the marketplace broker 128 operate as a singular entity, as shown at system 150 or not as shown at system 120. In at least one embodiment of the present disclosure, the each of the services 302 has associated therewith, service billing rules attributes 302a. For example, the service identifier “SKU-C3” includes the attributes “a,” “f,” and “p,” wherein ‘a’ indicates that SKU-C3 is aligned; ‘f’ indicates that it has a free first period; and ‘p’ indicates that it is prorated, for example, during cancellation.

In at least one embodiment of the present disclosure, the each of the monthly amount of consumed services in service units 312 is calculated by adding the each of the individual amount of the services, during particular billing periods 310. For example, during the billing period 310b (February), the total monthly amount of the services 312b includes the amount of the consumed services associated with SKU-A1, SKU-B2, SKU-C3(afp), SKU-C3 (afp), SKU-D4 (apf), and SKU-D4 (uff). It will be appreciated that the each of the monthly amount of the consumed services 312 are calculated by adding the each individual amount associated with the services 302, based on the each of the service attributes 302a. Then monthly amount of the consumed services is calculated per SKU, e.g. during the billing period 310b (February) SKU-C3—1.63, SKU-A1—0.16, SKU-B2—0.13, SKU-D4—1.35. It will be appreciated that the each of the monthly costs (or revenue, depending on contracting side—vendor or partner) may be calculated by multiplying monthly amount of the services in service units by price of service unit according to billing rules.

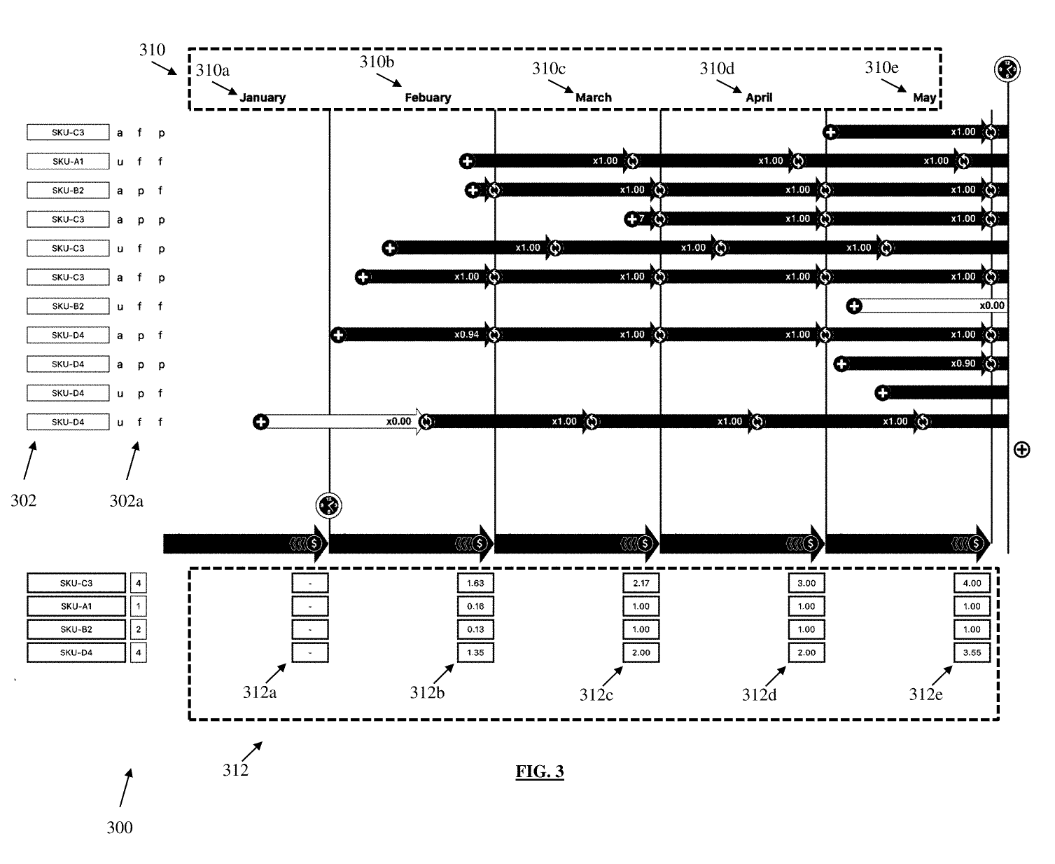

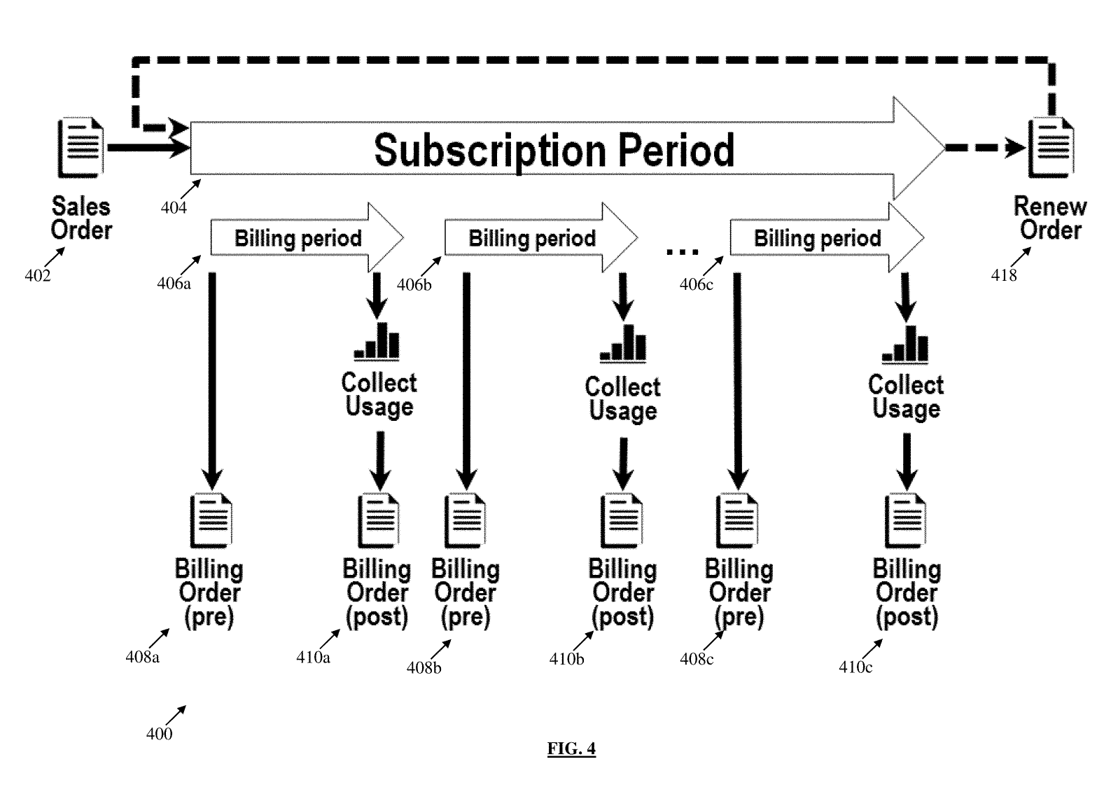

Referring now to FIG. 4, it is shown a flowchart and components of a method for matching revenue streams in a cloud service broker platform, generally indicated at 400. In at least one embodiment of the present disclosure, a sales order 402 is generated. The sale order 402 is indicative of a subscription period 404 wherein the subscription period is divided into a plurality of billing periods (406a, 406b, and 406c). For the each of the billing periods, a billing cost is calculated. For example, in billing period 406a, a billing pre-order 408a is calculated. At the end of the billing period 406a, usage is collected. At the end of the billing period 406a, a billing post-order 410a is calculated. It will be appreciated that the subscription period 404 may be divided into a plurality of billing periods based on the sales order 402, or some other agreed upon contract terms between the subscriber and the service providers (e.g. service vendor(s) 102, or resellers), or even the end customer.

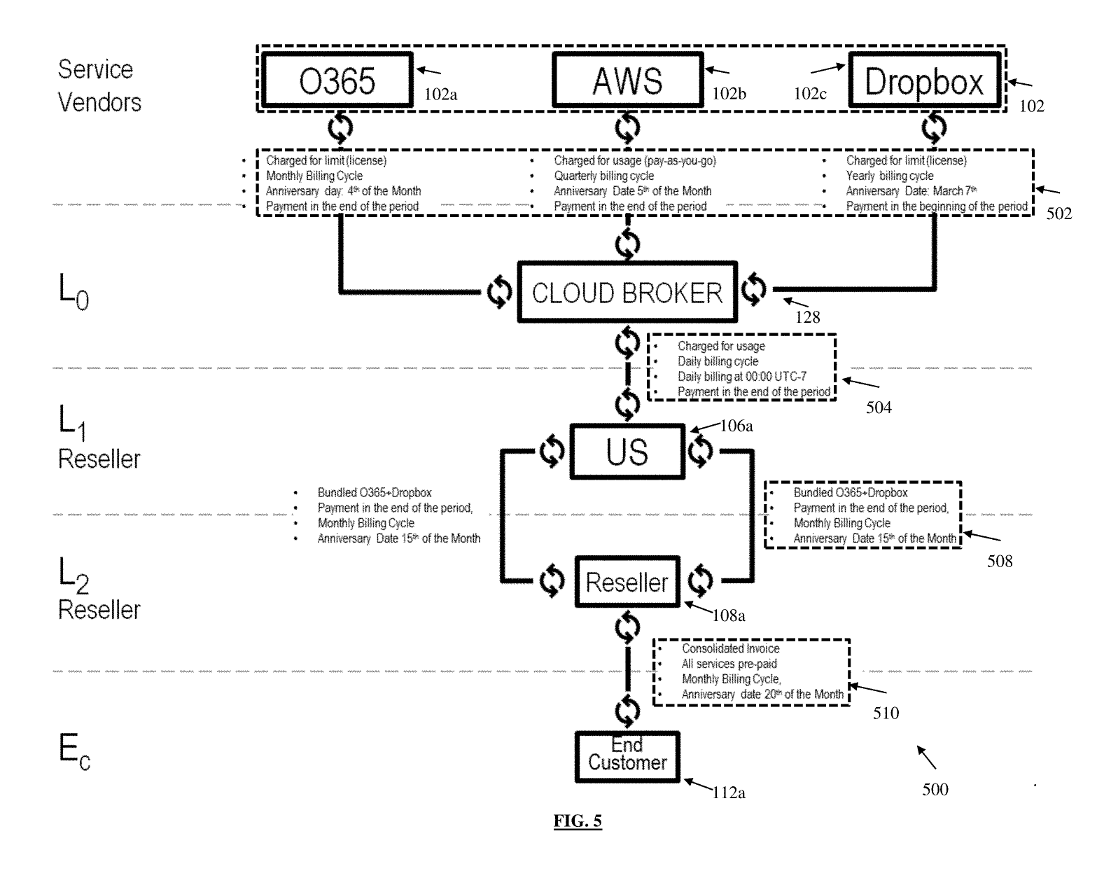

Referring now to FIG. 5, it is shown a method and components for matching revenue streams in a cloud service broker platform, generally indicated at 500. The method 500 includes steps 502 of calculating costs at the each of the service vendor(s) 102; step 504 of calculating service costs at the cloud broker (marketplace) 128; step 508 of calculating costs at the resellers 106a and 108a; and step 510 of generating a consolidated invoice for end customer(s) 112a.

In at least one embodiment of the present disclosure, costs are calculated for the each of the service vendor(s) 102, at step 502. For example, the cloud broker (marketplace) 128 has contract information for each of the service vendor(s) 102 from when the service vendor(s) 102 was first set up (i.e. made ‘available’). For each of the service vendor(s) 102, a contract based pricing scheme is developed. For example, service vendor(s) 102a may charge on a monthly billing cycle based on a license structure, with a billing anniversary falling on the 4^{th} day of the month, with payment in the end of the period. Similarly, service vendor(s) 102b, as an example, may change on a quarterly billing cycle based on a ‘pay-as-you-go’ scheme, with an anniversary date falling on the 5^{th}of the month, with payment at the end of the billing period.

In at least one embodiment of the present disclosure, costs are calculated at the cloud broker (marketplace) 128, at step 504. For example, the cloud broker (marketplace) 128 may have to generate billing invoices on a monthly billing period basis, even though service vendor(s) 102b bills on a quarterly basis. In such an exemplary embodiment, the cloud broker (marketplace) 128 is configured to calculate costs based on expected costs if the billing period of the service vendor is in the future.

In at least one embodiment of the present disclosure, costs are calculated for the resellers 106a and 108a, at step 508. Here again, the each of the resellers 106a and 108a may have independent contract terms such that the billing characteristics are different from that of the service vendor(s) 102. For example, at reseller 108a, service vendor(s) 102a (office365®) may have an anniversary date falling on the 15^{th} of the month, but as noted, service vendor(s) 102a bills on the 4^{th} of the month.

In at least one embodiment of the present disclosure, a consolidated invoice is generated for end customer(s) 112a, at step 510. It will be appreciated that for the end customer 112a, a single invoice is generated such that all costs arising from end customer 112a's subscription are generated onto a single invoice based on the end customer 112a's billing characteristics. It will be appreciated that the end customer 112a's billing characteristics may be different from that of the upstream entities (e.g. service vendor(s) 102, and resellers 106a and 108a).

Referring now to FIG. 6, it is shown a method for invoicing and reconciliation in a cloud service broker platform, generally indicated at 600. In at least one embodiment of the present disclosure, the method includes step 602 of the connector 138 reporting attributes of a provisioning operation to the transaction mediator 132; step 604 of the transaction mediator 132 storing the data in the service usage database 134; step 606 of the federated connector 130 requesting the service usage report for reconciliation with the service vendor(s) 102; step 608 of the transaction mediator 132 receiving billing rules of service vendor(s) 102 to determine service usage; step 610 of the transaction mediator 132 calculating the total usage of the service; step 612 of the transaction mediator 132 sending the report to the federated connector 130; step 614 of the federated connector 130 transmitting the report to the marketplace broker 128; step 616 of the marketplace broker 128 applying the pricing model of the service vendor(s) 102 to create a usage report for reconciliation with the service vendor(s) 102; step 618 of the federated connector 130 requesting the service usage report for partner 104a invoicing; step 620 of the transaction mediator 132 receiving billing rules from the partner 104a's subscription, and the transaction mediator 132 applying the billing rules to determine the service usage data; step 622 of the transaction mediator 132 calculating the total usage of the service; step 624 of the transaction mediator 132 sending the report to the federated connector 130; step 626 of the federated connector 132 transmitting the report to the marketplace broker 128; and step 628 of the marketplace broker 128 applying the pricing model from the partner 104a's subscription for usage report and invoicing the partner 104a.

Referring now to FIG. 7A and 7B, there is shown a system for matching revenue streams in a cloud service broker platform, generally indicated at 700, according to at least one embodiment of the present disclosure. The system 700 includes an independent software vendor (ISV) rating engine 702, a cost of sales calculator (cos. calculator) 704, and an enterprise resource planning (ERP) system 706.

In at least one embodiment of the present disclosure, the ISV rating engine 702 is operably connected to the transaction mediator 132. The ISV rating engine 702 is further configured to receive transaction information from transaction mediator 132 of the marketplace broker 128. By way of non-limiting examples, transaction types include activations, cancellations, changes, upgrades, downgrades, add-ons, usage collection, and the like. In at, least one embodiment of the present disclosure, the transaction mediator 132 transmits transactions to the ISV rating engine 702. It will be appreciated that each transaction from the transaction mediator 132 includes information such as, for example, resource identifiers, ISV contract identifiers, subscription identifiers, resource Stock Keeping Unit (SKU) values, transaction type, quantity, date, and the like. In at least one embodiment of the present disclosure, the information appurtenant to transactions is declared within the marketplace broker 128. In at least one embodiment of the present disclosure, the ISV rating engine 702 stores charges in a database operably connected to the ISV rating engine 702. It will be further appreciated that the ISV rating engine 702 is able to implement the price formation rules based on previous history of user transactions, such as discounts for volume, length of renewal period, other late price calculation rules.

In at least one embodiment of the present disclosure the cos. calculator 704, is configured to calculate the actual cost of sales for each of the transactions, or contracts occurring on the marketplace 128. In at least one embodiment of the present disclosure, contract terms in a contract between marketplace broker 128 and partner 104 or reseller 106 (depending on provisioning channel architecture, in other words, whether the cloud broker 104 and the marketplace broker 128 operate as a singular entity, as shown at system 700a or not as shown at system 700b) may differ from contract terms between marketplace broker 128 and service vendor(s) 102 (i.e. there is no dependency between these two contracts). It will be appreciated that the marketplace broker 128 may set up any billing rules and price formation rules for reseller 106, the marketplace broker 128 to be flexible and generate bigger revenue streams, when compared to the contract terms paid by marketplace broker 128 to service vendor(s) 102. By way of example, the marketplace broker 128 may sell a software bundle to a reseller 106 containing different applications developed by various service vendors and set up one subscription period for the whole bundle of applications; the marketplace broker 128 may also set up special discounts. However, the marketplace broker 128 will have to match its revenue streams from resellers (e.g. reseller 106) with the costs owed to service vendors (e.g. service vendor(s) 102).

In at least one embodiment of the present disclosure, the cos. calculator 704 is configured to facilitate automatic cost calculation. The cos. calculator 704 requests for estimation of costs for each resource SKU with periods defined by the contract between the marketplace broker 128 and reseller 106. from ISV rating engine 702. It will be appreciated that the from cos. calculator 704 leads to alignment of costs streams to revenue periods that are essential for further revenue matching and settlement, as disclosed herein. For example, some billing periods of a contract between marketplace broker 128 and reseller 106 may be longer than billing periods from a contract between marketplace broker 128 and service vendors 102. In such an embodiment, the ISV rating engine 702 provides an estimation of costs for future billing periods, based on transaction metrics received via transaction mediator 132.

In at least one embodiment of the present disclosure, enterprise resource planning (ERP) system 706, is operably connected to the ISV rating engine 702, or the marketplace 122. The ERP system 706 is of a type well known to one having ordinary skill in the art, such as, for example, SAP®, Microsoft Dynamics®, or the like. It will be appreciated that the ERP system 706 may be cloud based, and remote from the marketplace 122, or may be a component of the marketplace 122. In at least one embodiment, the ERP system 706 is configured to receive financial and other data, and collectively operable to perform the functions delegated to the ERP system 706 according to the present disclosure.

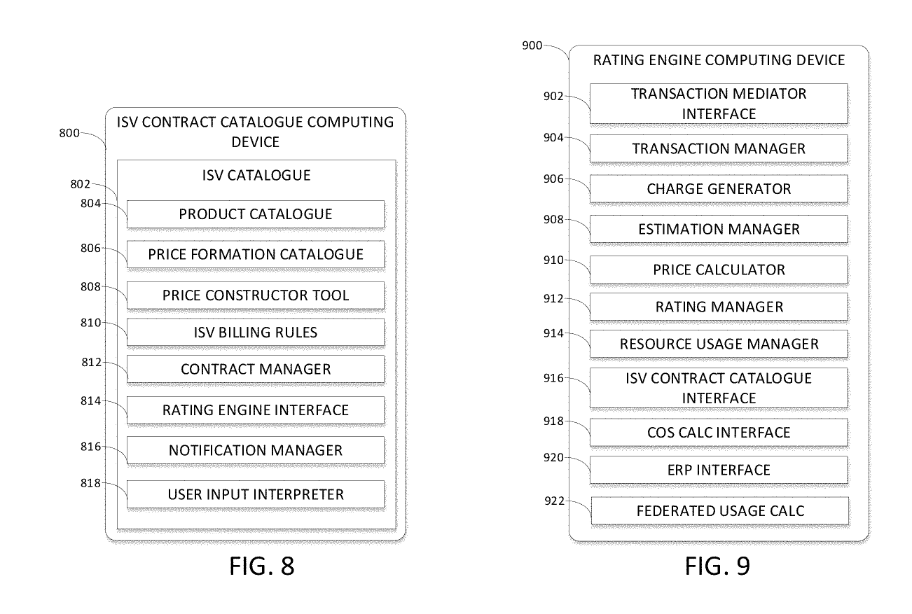

Referring now to FIG. 8, there is shown an ISV contract catalog computing device, generally indicated at 800. In at least one embodiment of the present disclosure, the ISV contract catalog computing device 800 includes an ISV catalog 802, an application catalog 804, a price formation catalog 806, a price constructor tool 808, an ISV billing rules manager 810, a contract manager 812., a rating engine interface 814, a notification manager 816, and a user input interpreter 818.

ISV catalog 802 is a service running on ISV contract catalog computing device 800. ISV catalog consists from several parts. Product catalog 804 stores information about available ISV services integrated with the cloud service broker marketplace system via connectors. It also contains a set of resources associated with services. Via price constructor tool 808 ISV can tune prices on services and resources usage. The price constructor tool 808 may contain a variety of price formation settings, e.g. dependencies from volume, period of use, special discounts for sonic type of clients, variety of arguments, on which price formula may depend, etc. ISV may use the variants of price settings, combine them and set its own price conditions, including a price condition in a form of mathematical formula. Price formation catalogue 806 stores price conditions set by ISV via the tool 808 or manually. ISV billing rules stores billing rules for services and associated resources. A variety of billing rules is depicted on the FIG. 2 202. Contract manager stores contract terms between ISVs and cloud service broker marketplace 128. Rating engine interface 814 is responsible for interfacing with rating engine, processing requests and responses. Notification manager 816 notifies rating engine and cloud service broker marketplace 128 about changes in product list, prices, billing rules or contracts from a ISV side. User input interpreter 818 is a UI for ISV, it helps ISV interacts with ISV catalogue service 802.

In at least one embodiment of the present disclosure, ISV contract catalogue device 800 inherits the service provider billing rules and service plans database 124. In at least one embodiment of the present disclosure the ISV contract catalog device 800 and hierarchical partner contract catalogue 126 may be combined as a product catalogue (not shown). In at least one embodiment of the present disclosure, the product catalogue may include at least one database with products including vendors' services with prices (set by vendor, set for partner, resellers etc.).

Referring now to FIG. 9, there is shown the components of an ISV rating engine computing device, generally indicated at 900. In at least one embodiment of the present disclosure, the ISV rating engine computing device includes a transaction mediator interface 902, transaction manager 904, a charge generator 906, a charge estimation manager 908, a price calculator 910, a rating manager 912, a resource usage manager 914, an ISV contract catalog interface 916, a cos. calculator interface 918, an ERP interface 920, and a federated usage calculator 922.

In at least one embodiment of the present disclosure, the resource usage manager 914 is configured to support a pay-as-you-go model, and receives transactions with usage from the transaction mediator 132. In at least one embodiment of the present disclosure, the federated usage calculator 922 inherits the functionality of the federated connector 130, and is configured to calculate usage per SKU and reports the same to the marketplace computing device 122.

Referring now to FIG. 10, there is shown a method 1000, for matching revenue streams in a cloud service broker platform, according to at least on embodiment of the present disclosure. In at least one embodiment of the present disclosure, the transaction mediator 132 transmits any transactions that include a “collect” request for any service resource, at step 1002. The method 1000 proceeds to step 1004 where the ISV rating engine 702 requests ISV catalog 802 about contract details for the service resource (e.g. price formation rules, etc.) and waits for usage reports. The transaction mediator 132 checks if the contract exists at step 1006, and then proceeds to step 1008 if it does; or proceeds to step 1036 if it does not. In at least one embodiment of the present disclosure, the transaction mediator 132 transmits usage reports to the ISV rating engine 702, at step 1008. The ISV rating engine 702 collects usage reports and creates charges with price according to price formation rules. For example, ISV rating engine 702 may create one charge per billing period associated with this resource set up with a service vendor(s) 102. In another case, when a contract, defines different prices for different amounts of resources, the ISV rating engine 702 may wait until this threshold is exceeded and creates a charge with a first price and then collects usage until the next threshold is reached and/or exceeded.

In at least one embodiment of the present disclosure, the ISV catalog 802 contains details about contracts between the marketplace broker 128 and the service vendor(s) 102. In particular, each contract between the marketplace broker 128 and the service vendor(s) 102 contains at least a set of applications, their descriptions, data about resources SKU, and resource identifiers (e.g. a service vendor number) associated with this application, subscription periods, price formation rules, currency, units of measure, billing rules for activation, cancellation, changes (e.g. add-on, upgrade, downgrade) and invoicing. It will be appreciated that the ISV catalog 802 also has a user interface for price formation rules setting, and a catalog with all possible price formation rules and price constructor tool with a user interface for a service vendor or other entity to set up price formation rules. It will be appreciated that the variety of price conditions are wide but preset. It will be further appreciated that at a minimum, a requirement is that these price formation rules must be resolved by the ISV rating engine 702 based on information contained in transactions from the transaction mediator 132 (i.e. the formula of price should be expressed in terms of variables reported by/to transaction mediator 132 or otherwise can be directly calculated based on them).

Continuing with method 1000, at step 1008, a check is made to see if the resource subscription associated with the received transaction exists. If it does, the method 1000 proceeds to step 1010; if it does not, the method 1000 proceeds to step 1038, where a check is made to see if the transaction is an “activation.”

At step 1010, the type of transaction is defined. In at least one embodiment of the present disclosure, an “activation” transaction is determined at step 1012 and is characterized by anniversary date with two attributes associated therewith: aligned (a), and unaligned (u), and three attributes associated with transaction activation: free, full, and prorated. If the transaction is indeed “activation,” the method 1000 proceeds to step 1058, where the transaction may be stored as ‘incorrect,’ because the contract already exists, as determined at step 1006. (Similarly, if the transaction is determined to be an “activation” as well, at step 1040, the method proceeds to step 1042; otherwise it proceeds to step 1036 where the transaction is stored as ‘inconsistent.’)

If the transaction is not an “activation,” the method 1000 proceeds to step 1014. At step 1014 it is determined whether the transaction is a “cancel.” In at least one embodiment of the present disclosure, a cancellation has three attributes associated therewith: free, full, prorated. If the transaction is not a cancellation, the method 1000 proceeds to step 1060.

If the transaction is a cancellation, the method 1000 proceeds to step 1016, where existing active resource subscriptions are identified, on the resource associated with the transaction. The method 1000 then proceeds to step 1018 where a service vendor 102 billing period is identified for the associated resource SKU. At step 1020, the ISV catalog 802 is queried to retrieve cancellation rules regarding the applicable contract with the service vendor(s) 102. At step 1022, a charge with a negative price is created, by resolving cancellation rules for the current billing period at step 1024, and then implementing the cancellation rules and calculating the negative price for cancellation at step 1026.

In at least one embodiment of the present disclosure, any estimation charges for further billing periods is determined at step 1028. If there are no such billing charges, the charges created from the preceding steps is stored at step 902. If there are charges to be stored, charges are created with negative prices for every estimation charge at step 1030, and prices are identified for estimation charges at step 1032. At step 1034, all created charges are stored and posted with the associated transaction.

Referring back to step 1040 of method 1000, if the transaction is an “activation,” the method 1000 proceeds to step 1042, as shown in FIG. 10A. In at least one embodiment of the present disclosure, the ISV catalog 802 is queried about the billing period associated with the resource SKU, at step 1044. The ISV catalog 802 is further queried about the set of price formation rules associated with the resource SKU, at step 1046. In at least one embodiment of the present disclosure, a charge is created with the end date of the furthest service vendor 102 billing date, at step 1048. For example, transaction data is identified at step 1050, price formation rules are resolved at step 1052, and the price is implemented at step 1054. At step 1056, the created charge is stored.

Referring back to step 1058 of method 1000, after the transaction is stored as “incorrect,” the method 1000 proceeds to step 1060, as shown in FIG. 10C. At step 1060, it is determined whether the transaction is a “change.” In at least one embodiment of the present disclosure, a change transaction has six attributes: three for old subscription—free, full, prorated; and three for new—free, full, prorated.

In at least one embodiment of the present disclosure, existing active resource subscriptions on the resource associated with the transaction are identified, at step 1062. The type of change transaction is identified at 1064, and the service vendor(s) 102 billing period is identified for the period associated with the resource SKU. The method 1000 then proceeds to step 1068 where the ISV catalog 802 is queried about the change rules from the contract with the service vendor(s) 102. It will be appreciated that the ISV catalog 802 may also be queried for price rules associated with the resource SKU and the type of change transaction. In at least one embodiment of the present disclosure, a change charge is created at step 1072 where change rules for the current billing period are resolved at 1080, and price and change rules are implemented at step 1082.

The method 1000 then proceeds to step 1090 where it is determined if there are any estimation charges for further billing periods. If no charges are to be stored, the method 1000 concludes at step 1092. Otherwise, charges with prices relevant to estimation charges associated with the resource for every estimation charge is created at step 1094. It will be further appreciated that the prices of estimation charges are identified at step 1096, and all created charges associated with the transaction are stored and posted at step 1098.

It will be appreciated that in CSB platform, a base price for resources is fixed and set by a contract between the service vendor 102 and marketplace broker 128. It will be further appreciated that there are several types of discounts: volume discount (with respect to subscriptions by units and where volume is a number of units; and with respect to pay-as-you-go subscriptions, volume is directly defined as a volume of purchased resource such as, memory, network bandwidth, and other computer resources to name a few non-liming examples). It will also be appreciated that discounts can be implemented based on the period of subscription renewals. For example, a first year discount may be 25%; a second year discount may be 35%, etc. The hierarchy of discounts may be set by the service vendor 102, and where discounts can be set as a percentage and as delta modification in money equivalent. It will be appreciated that discounts can be set as a combination of conditions.

In at least one embodiment of the present disclosure, late price calculation can be also set up. For example, if a subscriber during a year period purchases the amount of resource subscriptions above some threshold, a special discount can be implemented. For implementing late price calculations, transactions are stored and correction charges are issued, if some threshold for discount is being achieved. The ISV rating engine 702 receives transactions from transaction mediator 132 and after requesting contract details from the ISV catalog 802, implements price formation rules and billing rules for each resource SKU.

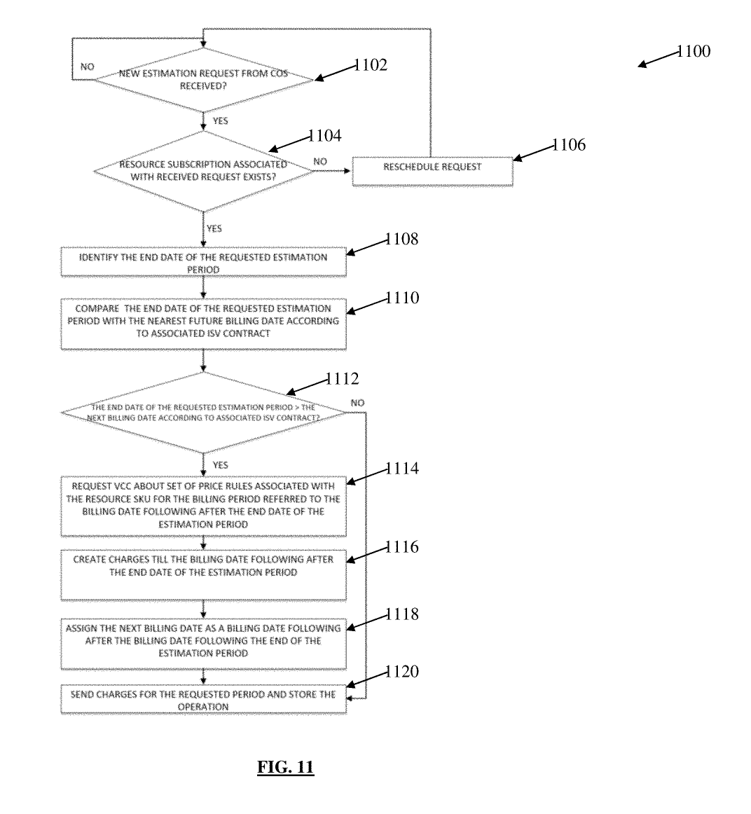

Referring now to FIG. 11, there is shown a method for matching revenue streams in a cloud service broker platform, generally indicated at 1100. The method 1100 demonstrates the operations of the ISV rating engine 702 in response to cos. calculator 704 requests, according to at least one embodiment of the present disclosure. The method 1100 begins at step 1102 where a new estimation request is received from a cos. calculator 704. The ISV rating engine 702 checks if a resource subscription associated with the received request exists at step 1104. If the request does not exist, the method 1100 proceeds to step 1106, and then loops to step 1102 again.

If the request does exist, the method 1100 proceeds to step 1108 where the end date of the requested estimation period is identified. At step 1110, the end date of the requested estimation period is compared with the nearest future billing date according to the associated contract with the applicable service vendor(s) 102.

In at least one embodiment of the present disclosure, the end date of the requested estimation period is checked to see if it is greater than the next billing date according to the associated contract with the applicable service vendor(s) 102, at step 1112. If it is not, the method 1100 proceeds to step 1120, as further disclosed herein.

Otherwise, the method 1100 proceeds to step 1114 where the ISV catalog 802 is queried about a set of price rules associated with the resource SKU for the billing period that is preferred, and the billing date following after the end date of the estimation period. At step 1116, charges are created for the billing date following the end date of the estimation period. At step 1118, the next billing date is assigned as a billing date following the billing date after the end of the estimation period. The method 1100 then concludes at step 1120 where the new charges are sent for the requested period and stored.

It will be appreciated that the ISV catalog 802 may contain rules for estimation. For example, if a service vendor (like Microsoft) has prepayment system, such a service vendor may set up rule that for the next billing period to calculate the average volume of consumed resources and prepare invoices according to such rules. It will be further appreciated that at the end of such a billing period the service vendor may send corrected invoices, where the ISV rating engine 702 may implement such corrections for estimation requests from cos. calculator 704.

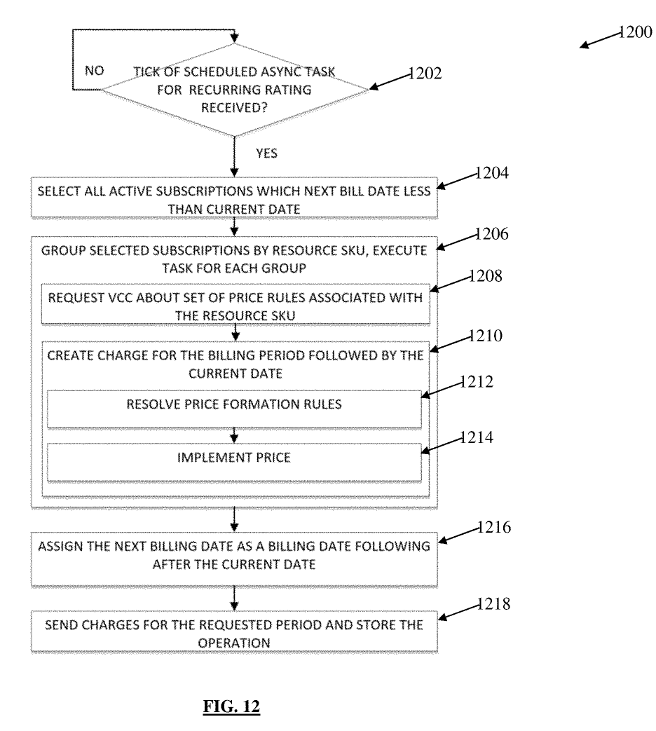

Referring now to FIG. 12, there is shown a method for matching revenue streams in a cloud service broker platform, generally indicated at 1200. The method 1200 demonstrates the operations of the ISV rating engine 702 to send recurring reports to ERP system 706, according to at least one embodiment of the present disclosure.

The method 1200 begins at step 1202 where a check is made to see if an asynchronous task for recurring ratings is received. It will be appreciated that the task may also be synchronous. If such a task is not received, the method 1200 loops back to 1202.

If a task is received, the method 1200 proceeds to step 1204 where all active subscriptions are selected where the next bill dates for such active subscriptions are less than the current date. The method 1200 then proceeds to step 1206 where the selected subscriptions are grouped by resource SKU, and the task is executed for each group.

In at least one embodiment of the present disclosure, the ISV catalog 802 is queried about the set of price rules associated with each applicable resource SKU, at step 1208. At step 1210, a charge for the billing period is created followed by the current date. Price formation rules are resolved at step 1212, and the price is implemented at step 1214.

In at least one embodiment of the present disclosure, the next billing date is assigned as a billing date following after the current date, at step 1216. The method 1200 concludes at step 1218 where the charges for the requested period are sent and stored.

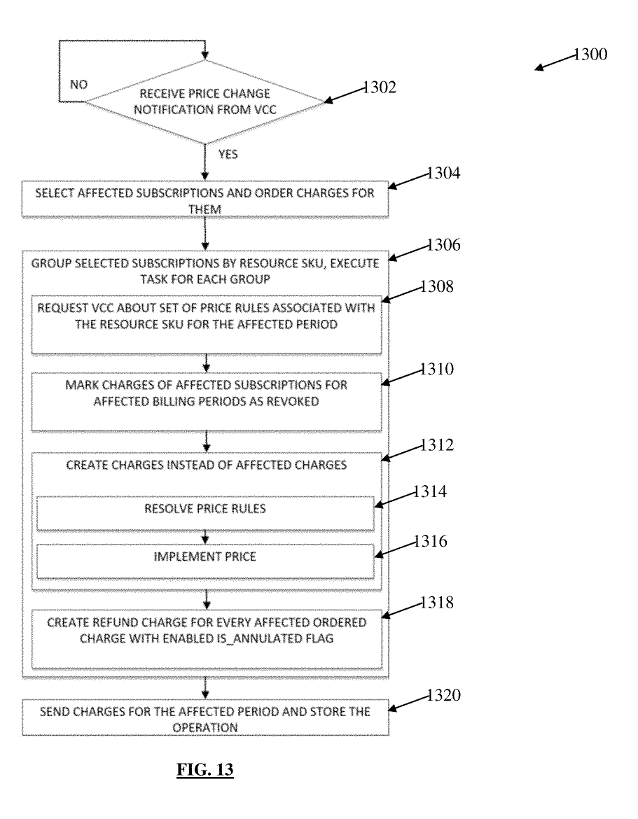

Referring now to FIG. 13, there is shown a method for matching revenue streams in a cloud service broker platform, generally indicated at 1300. The method 1300 demonstrates the operations of the ISV rating engine 702 to monitor changes in the ISV contract catalog 802, according to at least one embodiment of the present disclosure.

The method 1300 begins at step 1302 where the ISV rating engine 702 checks (periodically or continually) to see if it has received a price change notification from the ISV contract catalog 802. Upon receiving the notification, the method 1300 proceeds to step 1304 where affected subscriptions are selected, and charges are ordered. The method 1300 then proceeds to step 1306 where the selected subscriptions are grouped by resource SKU, and the task is executed for each group.

In at least one embodiment of the present disclosure, the ISV catalog 802 is queried about the set of price rules associated with each applicable resource SKU, at step 1308. At step 1310, any pending charges for affected subscriptions are revoked. The method 1300 then proceeds to step 1312 where a charge for the billing period is created. Price formation rules are resolved at step 1314, and the price is implemented at step 1316.

In at least one embodiment of the present disclosure, a refund charge may be created for ever affected ordered charge the previously overcharged, at step 1318. The method 1300 concludes at step 1320 where the charges for the affected period are sent and stored.

It will be appreciated that ISV rating engine 702 also receives updates from the ISV catalog 802 about price formation rules, which is bound to resources associated with the past transactions. It will be further appreciated that ISV rating engine 702 implements late price calculations and post correction charges in the end of the service vendor billing period related to conditions for late pricing. It will also be appreciated that all correction charges may be automatically reported to ERP system 706 with recurring cost reports as disclosed in method 12.

In at least one embodiment of the present disclosure, the cos. calculator 704 receives information about billing periods set up for contracts between marketplace broker 128 and reseller 106, by either: when marketplace broker 128 distributes cloud applications itself via the reseller chain, and where the CSB platform contains its own billing rules and all billing periods with which cost streams need to be matched; or, when the marketplace broker 128 has third-party partners and the partner platforms also contain their own billing. It will be appreciated that in such an embodiment, a marketplace computing device will include hierarchy participants' contract catalog with price and billing conditions for each partner. It will be further appreciated that the product catalog may be stored within the marketplace computing device, and preclude the need to store pricing information independently (i.e. at the hierarchy participants). In at least one embodiment of this disclosure, such a marketplace computing device has the same ISV rating engine for calculating revenue according to information received from the same transaction mediator 132 through the federated connector 130, for implementing price formation rules and billing rules from the partner contract catalog.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method for matching revenue streams in a cloud service broker platform, the method comprising:
receiving at an independent software vendor (ISV) rating engine, a transaction related to a software service;
defining at the ISV rating engine a type for the transaction, the type being selected from a group consisting of an activation, cancellation, or change;
requesting from an ISV catalog, at least one software service condition; and
implementing, at the ISV rating engine, an action, based at least in part on the at least one software service condition.

2. The method of claim 1, wherein the transaction type is an activation.

3. The method of claim 2, wherein the ISV catalog is queried for a first billing period and a price formation rule associated with the software service.

4. The method claim 3, wherein the action comprises a charge creation, wherein the charge creation comprises an end based at least in part on the first billing period date.

5. The method of claim 1, wherein the transaction is a cancellation.

6. The method of claim 5, wherein the ISV rating engine identifies a service vendor billing period associated with the software service.

7. The method of claim 6, wherein the ISV catalog is queried about at least one cancellation rule about the software service.

8. The method of claim 7, wherein the action comprises creating a negative price charge.

9. The method of claim 8, further comprising the step of resolving the at least one cancellation rule for a current billing period of the software service.

10. The method of claim 9, further comprising the step of implementing the at least one cancellation rule and calculating a negative price for cancellation.

11. The method of claim 7, further comprising the step of creating charges with negative prices for every estimation charge.

12. The method of claim 1, wherein the transaction is a change.

13. The method of claim 12, further comprising the step of identifying an existing active resource, the existing active resource associated with the transaction.

14. The method of claim 13, further comprising the step of identifying a service vendor billing period associated with the software service.

15. The method of claim 14, further comprising the step of querying the ISV catalog for any change rules regarding a contract with a service vendor, and any price rules associated with the software service.

16. The method of claim 15, further comprising the step of creating a change charge, the change charge based at least in part on a resolution of change rules for a current billing period, and implementing a price/rule change based at least in part on the change rules and price rules.

17. The method of claim 16, further comprising the step of calculating an estimation charge, the estimation charge comprising charges for any further billing periods.

18. The method of claim 17, wherein the action comprises creating a change charge, the change charge comprising the estimation charge.

19. The method of claim 1, wherein the at least one software service condition further comprises a conditional price formation and a late price formation.

20. The method of claim 19, wherein the conditional price formation comprises at least one billing rule for a pricing condition.

21. The method of claim 19, wherein the late price formation includes at least one late charge selected form a consisting of an order creation charge, an invoice creation charge, and charge set condition.

22. A method for matching revenue streams in a cloud service broker platform, the method comprising:
receiving at an independent software vendor (ISV) rating engine, a new estimation request, from a cost of sales calculator;
identifying at the ISV rating engine, an end date of the new estimation request;
comparing at the ISV rating engine, the end date, and a nearest future billing date, the nearest future billing date base at least in part on a contract between a service vendor and the cloud service broker platform;
requesting at the ISV rating engine, a plurality of price rules, from a ISV catalog, the plurality of price rules comprising a preferred billing period and a billing date of the new estimation request;
creating, at the cloud service broker platform, at least on charge for the billing date following after an end date of the new estimation request; and
assigning, at the cloud service broker platform, a next billing date comprising a billing date following the end date of the new estimation request.

23. The method of claim 22, further comprising the step of sending charges for the new estimation request to a database within the cloud service broker platform.

24. The method of claim 22, wherein the at least at least on charge further comprises a conditional price formation and a late price formation.

25. The method of claim 24, wherein the conditional price formation comprises at least one billing rule for a pricing condition.

26. The method of claim 24, wherein the late price formation includes at least one late charge selected form a consisting of an order creation charge, an invoice creation charge, and charge set condition.

27. A system for matching revenue streams in a cloud service broker platform, the system comprising:
a transaction mediator configured to receive all transaction about operations at an independent software vendor (ISV);
an independent software vendor (ISV) rating engine, operably connected to the cloud service broker platform, and configured to rate the transaction and transmit orders to an enterprise resource planning system;
a cost of sales calculator, operably connected to the cloud service broker platform, and configured to generate aligned charges based at least in part on aggregate revenues and customer cost charges; and
an ISV catalog, operably connected to the cloud service broker platform, and configured to store a plurality of contracts between the ISV and the cloud service broker platform.

28. The system of claim 27, wherein the transaction mediator is further configured to track all transactions flowing through the cloud service broker platform.

29. The system of claim 28, wherein the transaction mediator is further configured to report the transactions to the ISV rating engine.

30. The system of claim 28, wherein the transaction mediator is further configured transmit data for each of the independent software vendor.

31. The system of claim 27, wherein the each of the plurality of contracts comprises contract details selected from a group consisting of a set of software applications, software application descriptions, resources, resource identifiers, subscription periods, price formation rules, currency, unit of measure, billing rules for activation, cancellation, change, and invoicing.
